(19) United States
(12) Patent Application Publication
(10) Pub. No.: US 2013/0071821 A1
(43) Pub. Date: Mar. 21, 2013

(54) Systems, Computer Readable Program Products, and Computer Implemented Methods to Facilitate On-Demand, User-Driven, Virtual Sponsoring Sessions for One or More User-Selected Topics Through User-Designed Virtual Sponsors

(71) Applicants: Radoje T. Drmanac, Los Altos, CA (US); Snezana Drmanac, Los Altos, CA (US)

(72) Inventors: Radoje T. Drmanac, Los Altos, CA (US); Snezana Drmanac, Los Altos, CA (US)

(21) Appl. No.: 13/384,090

(22) PCT Filed: Apr. 30, 2010
(86) PCT No.: PCT/US10/33156

§ 371 Date: Nov. 21, 2012

Related U.S. Application Data
(60) Provisional application No. 61/174,761, filed on May 1, 2009.

(51) Int. Cl. G09B 19/00

(52) U.S. Cl. CPC G09B 19/00
USPC 434/236

(57) ABSTRACT

Exemplary embodiments of the present invention beneficially provide systems, computer-implemented methods, and computer-readable program products to facilitate a plurality of user-driven virtual sponsoring sessions for a plurality of users through one or more user-designed virtual sponsors where the topic of the virtual sponsoring session, the type of virtual sponsoring session, and the form of each virtual sponsoring statement is controlled by each of the plurality of users. The virtual sponsoring sessions can be for any subject matter domain through user-designed virtual sponsors that have no domain-specific knowledge, such that users are provided with real-time, on-demand access to virtual sponsoring services via a user-designed virtual sponsor designed and constructed responsive to the personality, preferences, and specifications of each individual user. Moreover, each user-designed virtual sponsor can be, for instance, capable of assisting each individual user to effectively generate change, strengthen identity and values, define goals, and bring dreams and goals into reality.

### BACKGROUND OF THE INVENTION

1. Field of the Invention

The present invention relates generally to the field of life coaching. More specifically, the present invention relates to the field of on-demand virtual life coaching through user-designed virtual sponsors where users interact with user-designed virtual sponsors via electronic media to determine and achieve personal goals, to evaluate and change core personal beliefs, to identify and solve personal problems, to find relaxation, and to find encouragement.

2. Description of Related Art

Life coaching is a process where one person, a life coach, assists another person, a client, to determine and achieve personal goals and to evaluate issues and problems of concern to the client. Life coaches are not licensed counselors, psychologists, or therapists, and life coaching does not focus on examining or diagnosing past life events or personal behaviors and does not attempt to diagnose mental illness or dysfunction. Moreover, life coaching is not consulting and accordingly, life coaches generally do not provide advice or instructions to the client. Rather, life coaching is action oriented and focuses on effectuating change in a client's current and future behavior by guiding the client through decision-making processes so that clients can determine their own answers to life's issues and concerns through the work done in partnership with their life coach.

Life coaching has its roots in executive coaching which draws on techniques developed as a part of management consulting and leadership training programs. Life coaching also draws insight from a variety of diverse disciplines such as sociology, psychology, positive adult development, career counseling, mentoring, and other types of counseling. Life coaches may apply mentoring techniques, values assessment methods, behavior modification techniques, behavior modeling practices, goal-setting processes, and other self-discovery techniques in assisting clients. As people spend greater hours at the workplace and become more isolated and competitive, more and more people will need the help of an expert professional life coach to resolve issues and make decisions.

Life coaches typically employ a variety of methods to assist clients with the process of setting and reaching personal goals, to evaluate and change personal goals, to identify and solve personal problems, to identify sources of stress and induce relaxation, and to identify personal challenges and provide encouragement. For instance, a coach may ask a series of intelligently selected statements, such as those used in NLP (neuro-linguistic programming) life coaching, in order to guide clients through a process of self-decision, self-motivation, and self-healing. Generally, life coaches can assume a variety of roles, including that of a motivator, a sounding board for discussion, a mediator, or a problem-solver. Moreover, life coaches can employ coaching techniques to achieve in the client a change in core personal beliefs. In sum, life coaching is a simple yet effective technique useful in all domains of life experience that assists people in making life decisions, from the most critical to the most mundane, in order to achieve greater satisfaction in life.

### SUMMARY OF THE INVENTION

Due to the often high cost of quality coaching services and the limited availability of professional life coaches, life coaching programs are often an unrealistic and unobtainable option for many people. For instance, expert life coaches traditionally are professionals who have undergone significant training and certification in the life coaching field. Although the life coaching profession is relatively new and self-regulating, self-appointed, privately-owned firms such as the International Coaching Council, the International Coach Federation, the International Association of Coaching, the Certified Coaches Federation, the European Coaching Institute, and the International Guild of Coaches, accredit various coaching schools as well as individual coaches. While any person can claim to be a life coach and offer coaching services, accredited coaches, who offer a higher-quality, more standardized, expert process, often charge a premium for their services thereby making such high-quality life coaching services out of reach for many individuals.

Moreover, an effective life coaching session, regardless of its form, necessarily requires the active participation of a life coach, and accordingly, many life coaching services are necessarily limited to the availability of the associated life coach. Thus, to accommodate a variety of different clients with different communication preferences and schedules, life coaches may choose, for instance, to provide services through face-to-face meetings, through telephone conferences, or even through Internet chat rooms. Nevertheless, many of life's critical decisions do not come to fruition during normal business hours, and while life coaches are highly accessible through a variety of media, life coaches often fail to be accessible at the most critical times for their clients. For example, an individual's life coach will likely be unavailable to assist that individual during the midnight hour when the individual cannot sleep due to an overbearing life decision. Moreover, life coaches cannot directly assist more than one client at a given time. An appointment with one client necessarily precludes an appointment with another client at the same time. Simply put, life coaches are not on-demand (e.g., available twenty-four hours a day, seven days a week) and available at all times to coach their clients as life's problems and issues arise. However flexible and available life coaches may be, life's issues and problems occur in real-time, without notice, and not according to any discernable schedule, and often, issues and problems will not wait until a life coach is available to guide and assist. Because life coaches cannot always be available in real-time when clients need them most, traditional life coaching services are only of partial assistance, and the full value of on-demand, real-time life coaching remains unrealized.

Additionally, even where a life coach is accessible, many individuals may be uncomfortable discussing personal life issues, problems, and decisions with a stranger. For instance, some individuals may be concerned that private information disclosed during a coaching session will not be kept confidential. Others may be unable to locate an available life coach that they can relate to on a personal level. Specifically, these clients may find that the physical appearance, personality, or even the tone of voice of available life coaches is incompatible with close and intimate conversation. Because a personal connection between a client and a coach is critical to the solution-focused coaching procedure which seeks to promote the development of new strategies for thinking and acting as opposed to trying to resolve problems and past conflicts, full and honest candor between the clients and life coaches is necessary for success of the coaching program. Presently, no solution exists to facilitate on-demand, real-time, confidential coaching services between clients and life coaches across the entire domain of life experiences where such coaches are virtual sponsors designed specifically to meet the individual needs and preferences of each client.

Accordingly, recognized is the need for systems, computer program products, and methods to facilitate virtual life coaching, or sponsoring, across all subject matter domains through user-designed virtual sponsors having no domain-specific knowledge such that users are provided with real-time, on-demand access to virtual sponsoring services via a virtual sponsor designed and constructed responsive to the personality, preferences, and specifications of each individual user and capable of assisting each individual user to effectively generate change, strengthen identity and values, define goals, and bring dreams and goals into reality. Examples of such topics amenable to virtual life coaching include, but are not limited to, stress reduction in one's job or personal life, lack of focus, lack of confidence or insecurity, relationship issues, fear, anxiety and phobias.

In view of the foregoing, exemplary embodiments of the present invention beneficially provide systems, computer implemented methods, and computer readable program products to facilitate a plurality of user-driven virtual sponsoring sessions for a plurality of users through one or more user-designed virtual sponsors where the topic of the virtual sponsoring session, the type of virtual sponsoring session, and the form of each virtual sponsoring statement is controlled by each of the plurality of users. Embodiments of the present invention, for instance, do not require pre-programmed, pre-selected instructional or educational materials. Rather, exemplary embodiments of the present invention work with a user to strengthen the user's identity and values, to bring dreams and goals into reality, and to help users reach personal goals, particularly where such dreams and personal goals are divergent to the educational goals associated with pre-selected, pre-programmed instructional materials. According to exemplary embodiments of the present invention, user-driven virtual sponsoring sessions are operable across the entire domain of life experiences without the addition of pre-selected, pre-programmed domain-specific knowledge of a particular subject matter. Thus, each user-designed virtual sponsor is capable of facilitating natural language communication with users for any subject matter and is capable of transitioning in real-time from one particular subject matter to another absent the time-consuming task of manually reprogramming the user-designed virtual sponsor to integrate with another particular subject matter domain. In sum, according to exemplary embodiments of the present invention, user-designed virtual sponsors are capable of adapting in real-time to new subject matter domains responsive to user input. In addition, each user-designed virtual sponsor is capable of calibrating to the emotional and psychological state of the user by monitoring various aspects of the user including, for example, the type of language-based communication used, voice quality, body language, facial expression, and vital signs. Various devices can be used to monitor the user, including, but not limited to, a camera to monitor body language and facial expressions, a microphone to monitor voice quality and a biofeedback device to monitor vital signs. Examples of biofeedback devices include, but are not limited to: heart rate devices, for example, oximeters, blood pressure monitors, pulse rate monitors; neurofeedback devices, for example electroencephalograms (EEG) and electrodermal response (EDR) machines; galvinic skin resistance monitors; temperature devices, for example, thermometers; electromyograms (EMG), and multi-modality devices, for example, caphograms. Furthermore, all of the user input data, user response data and user-driven virtual sponsoring sessions can be kept secure and confidential thereby alleviating concerns of confidentiality that can occur with human life coaches.

Moreover, embodiments of the present invention, for example, allow a user to design and create a virtual sponsor to meet the individual preferences of the user. Unlike human life coaches, user-designed virtual sponsors are available on-demand, twenty-four hours, seven days a week, whenever a user initiates a user-driven virtual sponsoring session. Furthermore, unlike human life coaches, user-designed virtual sponsors can be, for example, fully designed to the individual predilections of each user, including the personality, physical appearance, and vocal characteristics of a user-designed virtual sponsor. In addition, the user can choose the virtual sponsor to look or sound like himself or herself (e.g. the virtual sponsor can be an extended self), or the user can choose the virtual sponsor to look or sound like the user's life companion or a well-known person (e.g. celebrity, politician, famous person). Accordingly, exemplary embodiments of the present invention allow each user to design one or more user-designed virtual sponsors that are particularly suited, for instance, to facilitate real-time problem-solving and self-actualization processes for each individual user.

An exemplary embodiment of the present invention can include, for instance, a system to facilitate an on-demand, user-driven, virtual sponsoring session for one or more user-selected topics through user-designed virtual sponsors. Such a system, for example, can include a virtual sponsor computer, a user computer, and a communications network. The virtual sponsor computer, for example, can have at least a processor, a memory, an input device, an output device, and first, second, third, fourth, and fifth databases. The virtual sponsor computer, for example, can be positioned to receive a plurality of personal user data and a set of virtual sponsoring session preferences from one of a plurality of users to be associated with, and stored in, one of a plurality of personal user profiles. Additionally, the virtual sponsor computer can be positioned to facilitate the design and creation of one or more user-designed virtual sponsors and to facilitate a user-driven virtual sponsoring session for the one of a plurality of users.

The user computer, for example, can have at least a processor, an input device, an output device, and a memory, and can be positioned to associate with one of the plurality of users positioned remote from and in communication with the virtual sponsor computer. Beneficially, the communications network can be positioned to be in communication with the virtual sponsor computer and the user computer through the respective input device and output device of the virtual sponsor computer and the user computer. An exemplary user-driven virtual sponsoring system to facilitate an on-demand, virtual sponsoring session for one or more user-selected topics through user-designed virtual sponsors can also include, for instance, a computer readable program product that is readable by the virtual sponsor computer and stored in the memory of the virtual sponsor computer. The computer readable program product can include, for example, a virtual sponsoring session initialization module, a virtual sponsoring control module responsive to the virtual sponsoring session initialization module, and a virtual sponsoring session module responsive to the virtual sponsoring control module.

The virtual sponsoring session initialization module can include, for instance, a user-designed virtual sponsor generator and a user-driven virtual sponsoring session generator. The user-designed virtual sponsor generator can, for instance, generate a user-designed virtual sponsor to be stored in the second database and associated with the personal user profile of the one of the plurality of users. Additionally, the user-designed virtual sponsor generator can be responsive to virtual sponsor characteristics data generated by selection, by the one of the plurality of users, of one or more physical characteristics of a virtual sponsor, one or more vocal characteristics of a virtual sponsor, and one or more personality characteristics of a virtual sponsor so that a collective combination of the selected one or more physical characteristics of a virtual sponsor, one or more vocal characteristics of a virtual sponsor, and one or more personality characteristics of a virtual sponsor generate a user-designed virtual sponsor. Moreover, the user-driven virtual sponsoring session generator, for example, can generate a user-driven virtual sponsoring session responsive to the user-designed virtual sponsor generator and responsive to receiving from the user computer via the communications network the set of virtual sponsoring session preferences to be associated with the personal user profile of the one of the plurality of users and stored in the third database.

Beneficially, the virtual sponsoring control module can include a user-driven virtual sponsoring session controller to control the user-driven virtual sponsoring session based on the personal user profile of the one of the plurality of users and responsive to receiving during the user-driven virtual sponsoring session one or more user-driven virtual sponsoring session controls from the user computer to be associated with the personal user profile of the one of the plurality of users. The virtual sponsoring control module can also include, for example, a user-designed virtual sponsor design controller to control the design of the user-designed virtual sponsor based on the personal user profile of the one of the plurality of users and responsive to receiving, during the user-driven virtual sponsoring session, user input data. Additionally, the virtual sponsoring control module can include a user-driven virtual sponsoring session terminator to terminate the user-driven virtual sponsoring session responsive to receiving a sponsoring session termination signal from the user computer via the communications network.

The virtual sponsoring session module can be, for instance, responsive to the virtual sponsoring control module and can have an initial statement presenter, a next statement presenter, and a new statement creator. Statements, as used herein, can include, for example, statements of fact, questions, statements of inquiry, rephrasing of user-derived statements and verbal content reframing. Moreover, the initial statement presenter, for instance, can present to the user computer via the communications network, responsive to the virtual sponsoring control module, one or more virtual sponsoring statements selected from one or more of the plurality of lists of virtual sponsoring statements stored in the fourth database and associated with at least one of the one or more user-driven virtual sponsoring session controls. Additionally, the next statement presenter can present to the user computer via the communications network, responsive to the virtual sponsoring control module and user response data received from the user computer via the communications network responsive to each of the one or more presented virtual sponsoring statements, one or more virtual sponsoring statements selected from one or more of the plurality of lists of virtual sponsoring statements stored in the fourth database and associated with at least one of the one or more user-driven virtual sponsoring session controls. Responsive to the user-driven virtual sponsoring session controller and the user response data and based on one or more of the plurality of virtual sponsoring statement components stored in the fifth database, the new statement creator, can create, for example, one or more new virtual sponsoring statements different from the virtual sponsoring statements in each of the plurality of lists of virtual sponsoring statements. Such new virtual sponsoring statements can include, for example, rephrasing of user-derived statements in a question format, for example, the user states “I had a bad day.” and the new statement creator responds with “You had a bad day?”. Moreover, the new statement creator, for instance, can categorize the created one or more new virtual sponsoring statements by topic, store the created one or more new virtual sponsoring statements in one or more of the plurality of lists of virtual sponsoring statements stored in the fourth database, and transmit to the user computer, via the communications network, the one or more new virtual sponsoring statements.

Another exemplary embodiment of the present invention can include, by way of example, a computer-implemented method to facilitate an on-demand, user-driven, virtual sponsoring session for one or more user-selected topics through user-designed virtual sponsors. Such a computer implemented method can include the step of generating, via a computer, a personal user profile derived from a plurality of personal user data received from a remote user interface device via a communications network and associated with the one of the plurality of users to be stored in the personal user profile stored in a first database. Responsive to the user profile of the one of the plurality of users, the computer implemented method can further include, for example, the step of generating, via the computer, a user-designed virtual sponsor to be stored in a second database and associated with the personal user profile of the one of the plurality of users. The operation of generating the user-designed virtual sponsor can, for instance, be responsive to virtual sponsor characteristics data generated by selection, by the one of the plurality of users, of one or more physical characteristics of a virtual sponsor, one or more vocal characteristics of a virtual sponsor, and one or more personality characteristics of a virtual sponsor so that a collective combination of the selected one or more physical characteristics of a virtual sponsor, one or more vocal characteristics of a virtual sponsor, and one or more personality characteristics of a virtual sponsor generate a user-designed virtual sponsor.

Furthermore, the computer implemented method can include, for example, the step of generating, via the computer, a user-driven virtual sponsoring session responsive to generating the user-designed virtual sponsor and responsive to receiving from the remote user interface device via the communications network the set of virtual sponsoring session preferences to be associated with the personal user profile of the one of the plurality of users and stored in a third database. Beneficially, the computer implemented method according to an embodiment of the present invention includes the steps of controlling, via the computer, the user-driven virtual sponsoring session based on the personal user profile of the one of the plurality of users and responsive to receiving during the user-driven virtual sponsoring session one or more user-driven virtual sponsoring session controls from the remote user interface device to be associated with the personal user profile of the one of the plurality of users, and controlling via the computer, the design of the user-designed virtual sponsor based on the personal user profile of the one of the plurality of users and responsive to receiving, during the user-driven virtual sponsoring session, user input data.

The computer implemented method can additionally include, for example, the steps of presenting to the remote user interface device via the communications network, responsive to the operation of controlling the user-driven virtual sponsoring session, one or more virtual sponsoring statements selected from one or more of the plurality of lists of virtual sponsoring statements stored in a fourth database and associated with at least one of the one or more user-driven virtual sponsoring session controls, receiving user response data from the remote user interface device via the communications network responsive to each of the one or more presented virtual sponsoring statements, and securely storing the user response data. Additionally, such a computer implemented method can include, for example, the step of presenting to the remote user interface device via the communications network, responsive to the operation of controlling the user-driven virtual sponsoring session and user response data received from the remote user interface device via the communications network responsive to each of the one or more presented virtual sponsoring statements, one or more virtual sponsoring statements selected from one or more of the plurality of lists of virtual sponsoring statements stored in the fourth database and associated with at least one of the one or more user-driven virtual sponsoring session controls. In addition to the aforementioned steps, a computer implemented method according to an exemplary embodiment of the present invention can further include, by way of example, the step of creating, via the computer, responsive to the user response data and based on one or more of the plurality of virtual sponsoring statement components stored in a fifth database, one or more new virtual sponsoring statements to be categorized by topic, stored in the one or more of the plurality of lists of virtual sponsoring statements stored in the fourth database, and transmitted to the remote user interface device, via the communications network.

Another exemplary embodiment of the present invention can provide for a user-driven co-coaching sponsoring session for one or more user-selected topics. Co-coaching is a structured practice of mutual exchange of coaching support among, for example, peers, family members, friends, colleagues and the like, and comprises a range of practices that includes, but is not limited to, a plurality of users, each of whom take turns acting as a coach in a session. The first of the plurality of users is the user that is in need of the co-coaching sponsoring session and the second of the plurality of users is the user that assumes the role of the sponsor. The first and second users can be positioned remote from and in communication with each other. According to embodiments of the present invention, the co-coaching sponsoring session utilizes the virtual sponsoring session computer readable program described herein to provide to the second user with the virtual sponsoring statements selected from the one or more of the plurality of lists of virtual sponsoring statements stored in the fourth and fifth databases and associated with at least one of the one or more user-driven virtual sponsoring session controls.

In yet a further embodiment of the present invention, the computer implemented method to facilitate an on-demand, user-driven virtual sponsoring session for one or more user-selected topics through user-designed virtual sponsors can be utilized for entertainment purposes and for self-improvement through game and entertainment formats. For example, users can play a game in which they are asked the virtual sponsoring statements. The computer implemented method can design a coaching game wherein the user can be guided through the game and thereby be led to self discovery and self improvement (e.g. obtain a better understanding of his or her needs, wishes, limitations, conflicts and the like).

In yet a further embodiment of the invention, the user can generate his or her past experiences by creating a movie, for example a cartoon or video of the user, wherein the user writes the scenario. In addition to being able to edit past memories or experiences that are not desirable, the virtual sponsor computer program can assist the user to create new memories and experiences and thereby guide the user to self discovery and self improvement.

Various embodiments of the present invention provide at least nine primary benefits: (1) exemplary embodiments of the present invention can provide high-quality sponsoring services at a low cost to each of the plurality of users; (2) embodiments of the present invention can provide virtual sponsoring sessions on-demand, at any time and at any place; (3) embodiments of the present invention can allow each of the plurality of users to select and design the physical, vocal, and personality characteristics of a user-designed virtual sponsor; (4) embodiments of the present invention can allow each of the plurality of users to bookmark virtual sponsoring session progress, pause an associated virtual sponsoring session, and return to the associated virtual sponsoring session at a later date as if the session was never paused; (5) embodiments of the present invention can facilitate user-driven virtual sponsoring sessions in a completely confidential manner; (6) embodiments of the present invention can facilitate user-driven virtual sponsoring sessions for any subject matter; (7) embodiments of the present invention can facilitate user-driven virtual sponsoring sessions that adapt, in real time, to new subject matter issues raised by each of the plurality of users; (8) embodiments of the present invention can facilitate user-driven virtual sponsoring sessions that can create new virtual sponsoring statements responsive to user input data thereby providing each of the plurality of users with a limitless set of virtual sponsoring statements to be used in one or more user-driven virtual sponsoring sessions; and (9) embodiments of the present invention can facilitate user-driven co-coaching sponsoring sessions that allow multiple users to access the virtual sponsoring statements to be used to sponsor or coach other users.

### BRIEF DESCRIPTION OF THE DRAWINGS

So that the manner in which the features and benefits of the invention, as well as others which will become apparent, can be understood in more detail, a more particular description of the various embodiments of the invention can be had by reference to the embodiments thereof which are illustrated in the appended drawings, which form a part of this specification. It is also to be noted, however, that the drawings illustrate only various embodiments of the invention and are therefore not to be considered limiting of the scope of the invention as it can include other effective embodiments as well.

FIG. 1 is a schematic block diagram of a distributed system to facilitate an on-demand, user-driven, virtual sponsoring session for one or more user-selected topics through user-designed virtual sponsors according to an exemplary embodiment of the present invention.

FIG. 2 is a schematic block diagram of a distributed system to facilitate an on-demand, user-driven, virtual sponsoring session for one or more user-selected topics through user-designed virtual sponsors according to an exemplary embodiment of the present invention.

FIG. 3 is a schematic block diagram of a system, entirely within a single computer, to facilitate an on-demand, user-driven, virtual sponsoring session for one or more user-selected topics through user-designed virtual sponsors according to an exemplary embodiment of the present invention.

FIG. 4 is a schematic block diagram of a system to facilitate an on-demand, user-driven, virtual sponsoring session for one or more user-selected topics through user-designed virtual sponsors where a copy of the virtual sponsor computer program product is downloaded from a virtual sponsor download computer to a virtual sponsor user computer and executed by the virtual sponsor user computer according to an exemplary embodiment of the present invention.

FIG. 5 is a schematic database model diagram of a system to facilitate an on-demand, user-driven, virtual sponsoring session for one or more user-selected topics through user-designed virtual sponsors according to an exemplary embodiment of the present invention.

FIG. 6 is a schematic Unified Modeling Language activity diagram, from the perspective of the virtual sponsor computer, of a system, method, and computer readable program product to facilitate an on-demand, user-driven, virtual sponsoring session for one or more user-selected topics through user-designed virtual sponsors according to an exemplary embodiment of the present invention.

FIG. 7 is a schematic Unified Modeling Language activity diagram, from the perspective of the virtual sponsor user computer, of a system, method, and computer readable program product to facilitate an on-demand, user-driven, virtual sponsoring session for one or more user-selected topics through user-designed virtual sponsors according to an exemplary embodiment of the present invention.

FIG. 8 is a schematic Unified Modeling Language use case diagram of a system, method, and computer readable program product to facilitate an on-demand, user-driven, virtual sponsoring session for one or more user-selected topics through user-designed virtual sponsors according to an exemplary embodiment of the present invention.

FIG. 9 is a schematic Unified Modeling Language activity diagram showing the virtual sponsor characteristics that a virtual sponsoring session user can select to thereby design one or more physical characteristics, vocal characteristics, and personality characteristics of a user-designed virtual sponsor so that a collective combination of the selected one or more physical characteristics, vocal characteristics, and personality characteristics create a user-designed virtual sponsor according to an exemplary embodiment of the present invention.

FIG. 10 is a schematic Unified Modeling Language activity diagram of a user-driven virtual sponsoring session controller of a system to facilitate an on-demand, user-driven, virtual sponsoring session for one or more user-selected topics through user-designed virtual sponsors, according to an exemplary embodiment of the present invention.

FIG. 11 is a schematic Unified Modeling Language activity diagram of a virtual sponsoring initialization module of a system to facilitate an on-demand, user-driven, virtual sponsoring session for one or more user-selected topics through user-designed virtual sponsors, according to an exemplary embodiment of the present invention.

FIG. 12 is a schematic diagram of a graphical user interface facilitating the design of one or more physical characteristics of a user-designed virtual sponsor by one of a plurality of users according to an exemplary embodiment of the present invention.

FIG. 13 is a schematic diagram of a graphical user interface facilitating the design of one or more vocal characteristics of a user-designed virtual sponsor by one of a plurality of users according to an exemplary embodiment of the present invention.

FIG. 14 is a schematic diagram of a graphical user interface of an on-demand, user-driven virtual sponsoring session according to an exemplary embodiment of the present invention.

### DETAILED DESCRIPTION

The present invention will now be described more fully hereinafter with reference to the accompanying drawings which illustrate various embodiments of the invention. This invention, however, may be embodied in many different forms and should not be construed as limited to the embodiments set forth herein. Rather, these embodiments are provided so that this disclosure will be thorough and complete, and will fully convey the scope of the invention to those skilled in the art. It is to be fully recognized that the different teachings of the various embodiments discussed below may be employed separately or in any suitable combination to produce desired results. The various characteristics mentioned above, as well as other features and characteristics described in more detail below, will be readily apparent to those skilled in the art upon reading the following detailed description of the various embodiments, and by referring to the accompanying drawings. In the drawings and description that follows, like parts are marked throughout the specification and drawings with the same reference numerals, respectively. The prime notation, if used, indicates similar elements in alternative embodiments. The drawings are not necessarily to scale. Certain features of the disclosure may be shown exaggerated in scale or in somewhat schematic form and some details of conventional elements may not be shown in the interest of clarity and conciseness.

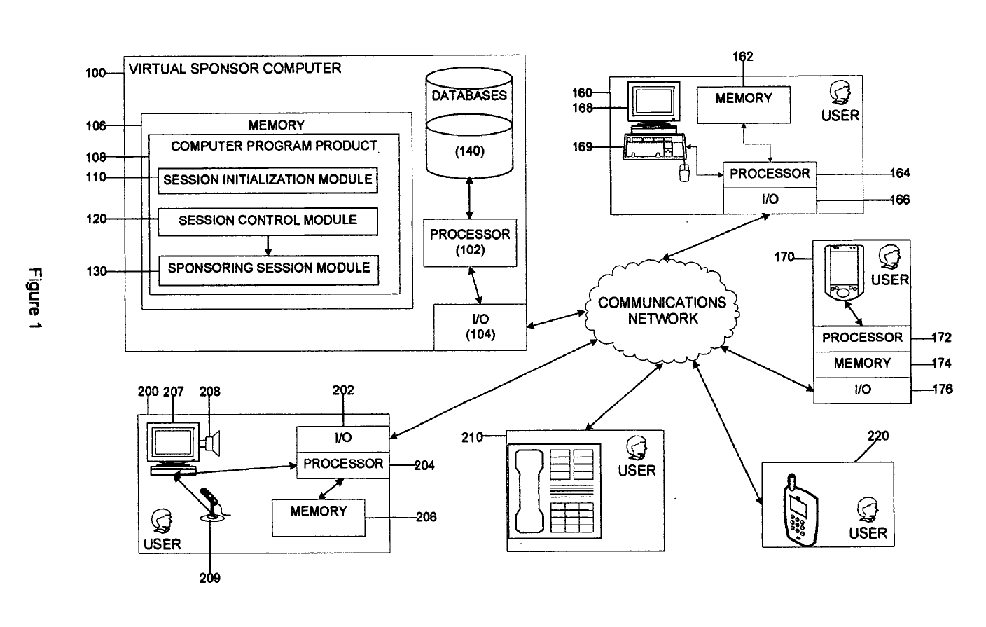

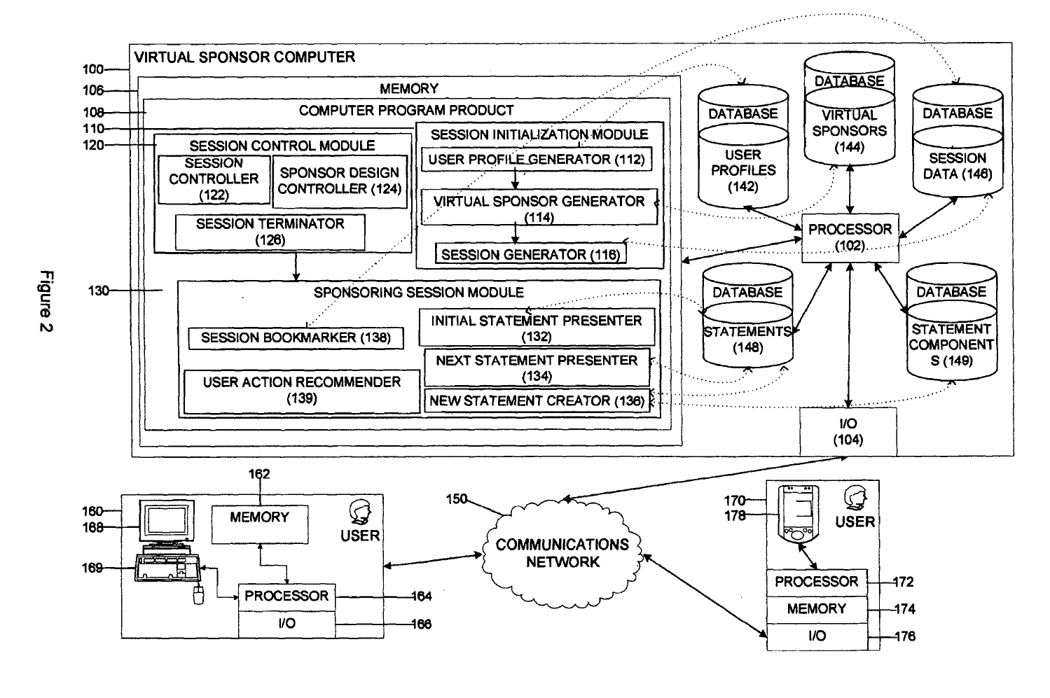

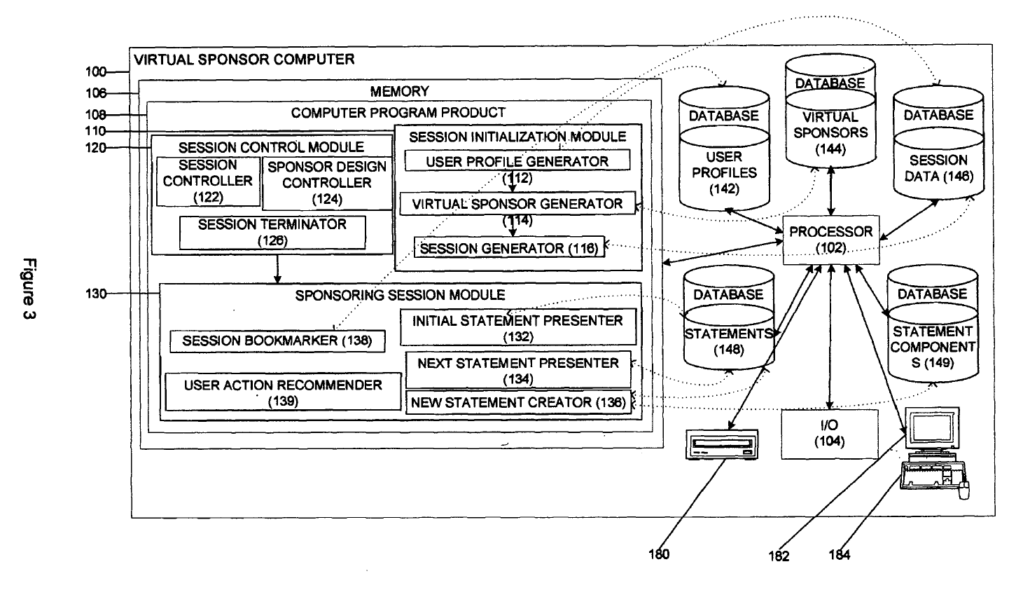

Exemplary embodiments of the present invention advantageously provide, for example, systems, computer program products, and related computer implemented methods to facilitate an on-demand virtual sponsoring session for any subject matter through user-designed virtual sponsors. FIG. 1 and FIG. 2, for example, illustrate a user-driven virtual sponsoring system to facilitate an on-demand, user-driven, virtual sponsoring session for one or more user-selected topics through user-designed virtual sponsors. Such a system, for example, can include a virtual sponsor computer 100, a user computer 160, and a communications network 150. The virtual sponsor computer 100, for example, can have at least a processor 102, a memory 106, an input device 104, an output device 104, and first, second, third, fourth, and fifth databases 140. For example, the first database 142 can include a plurality of user profiles, the second database 144 can include a plurality of virtual sponsor data files, the third database 146 can include a plurality of virtual sponsoring session data, the fourth database 148 can include a plurality of lists of virtual sponsor statements, each associated with at least one of one or more user-driven virtual sponsoring session controls, and the fifth database 149 can include a plurality of virtual sponsoring statement components. The virtual sponsor computer 100 for example, can be positioned to receive a plurality of personal user data and a set of virtual sponsoring session preferences from one of a plurality of users to be associated with, and stored in, one of a plurality of personal user profiles. Additionally, the virtual sponsor computer 100 can be positioned to facilitate the design and creation of one or more user-designed virtual sponsors and to facilitate a user-driven virtual sponsoring session for the one of a plurality of users.

The user computer 160, for example, can have at least a processor 164, an input device 166, an output device 166, and a memory 162 and can be positioned to associate with one of the plurality of users positioned remote from and in communication with the virtual sponsor computer. Moreover, as perhaps best illustrated in FIG. 1, the user computer can include electronic speakers 208, a microphone 209, a keyboard 169, and a mouse 161. Additionally, the user computer can include a projection device. The electronic speakers 208, for example, can include computer speakers, multimedia speakers, studio monitors, headphones, in-ear monitors, handset speakers, loud speakers, public address system speakers, subwoofers, woofers, mid-range speakers, tweeters, super-tweeters, or any other electro-acoustical transducer that converts an electrical signal to sound as is known and understood by those skilled in the art. The microphone 209, for example, can include a wireless microphone, a handset microphone, a computer microphone or any other acoustic-to-electric transducer or sensor that converts sound into an electrical signal. The keyboard 169 can include, for example, an alphanumeric keyboard, an IBM PC keyboard, an Apple keyboard, a chorded keyboard, a brail keyboard, a numeric keypad, a stenograph, a QWERTY keyboard, and any other electronic keyboard as is known and understood by those skilled in the art. The mouse 161 can include, for example, a mechanical mouse, an optical mouse, a three-dimensional mouse, a gyroscopic mouse, a inertial mouse, a double mouse system, a track ball, a laser mouse, or any other pointing device that detects motion relative to a supporting surface as is known and understood by those skilled in the art. The projection device can include, for example, a video projector, a three-dimensional projector, a holograph projector, or any other projection device that projects images as is known and understood by those skilled in the art.

Beneficially, the communications network 150 can be positioned to be in communication with the virtual sponsor computer 100 and the user computer 160 through the respective input device 104, 166 and output device 104, 166 of the virtual sponsor computer 100 and the user computer 160. An exemplary user-driven virtual sponsoring system to facilitate an on-demand, virtual sponsoring session for one or more user-selected topics through user-designed virtual sponsors can also include, for instance, a computer readable program product 108 that is readable by the virtual sponsor computer 100 and stored in the memory 106 of the virtual sponsor computer 100. The computer readable program product 108, can include, for example, a virtual sponsoring session initialization module 110, a virtual sponsoring control module 120 responsive to the virtual sponsoring session initialization module 110, and a virtual sponsoring session module 130 responsive to the virtual sponsoring control module 120. As illustrated by FIG. 2, the virtual sponsoring session initialization module 120 can include, for instance, a user profile generator 112, a user-designed virtual sponsor generator 114, and a user-driven virtual sponsoring session generator 116.

The user profile generator 112, for example, can generate a personal user profile derived from a plurality of personal user data received from the user computer 160 via the communications network 150 and associated with the one of the plurality of users, and can store the personal user profile in the first database 142. The user-designed virtual sponsor generator 114 can, for instance, generate, responsive to the user profile generator 112, a user-designed virtual sponsor to be stored in the second database 144 and associated with the personal user profile of the one of the plurality of users. Additionally, the user-designed virtual sponsor generator 114 can be responsive to virtual sponsor characteristics data generated by selection, by the one of the plurality of users, of one or more physical characteristics of a virtual sponsor, one or more vocal characteristics of a virtual sponsor, and one or more personality characteristics of a virtual sponsor so that a collective combination of the selected one or more physical characteristics of a virtual sponsor, one or more vocal characteristics of a virtual sponsor, and one or more personality characteristics of a virtual sponsor generate a user-designed virtual sponsor. Furthermore, the user-designed virtual sponsor generator can be responsive to virtual sponsor characteristics data generated by selection, by one of the plurality of users, of one or more text-writing display characteristics that can be used in the absence of voice and visual displays. Moreover, the user-driven virtual sponsoring session generator 116, for example, can generate a user-driven virtual sponsoring session responsive to the user-designed virtual sponsor generator 114 and responsive to receiving from the user computer 160 via the communications network 150 the set of virtual sponsoring session preferences to be associated with the personal user profile of the one of the plurality of users and stored in the third database 146. The set of virtual sponsoring session preferences can include, for example, one or more preferred sponsoring session types and one or more preferred sponsoring statement forms, and the user-driven virtual sponsoring session can be based, for example, on the personal user profile of the one of the plurality of users, the user-designed virtual sponsor designed by the one of the plurality of users, and the set of virtual sponsoring preferences.

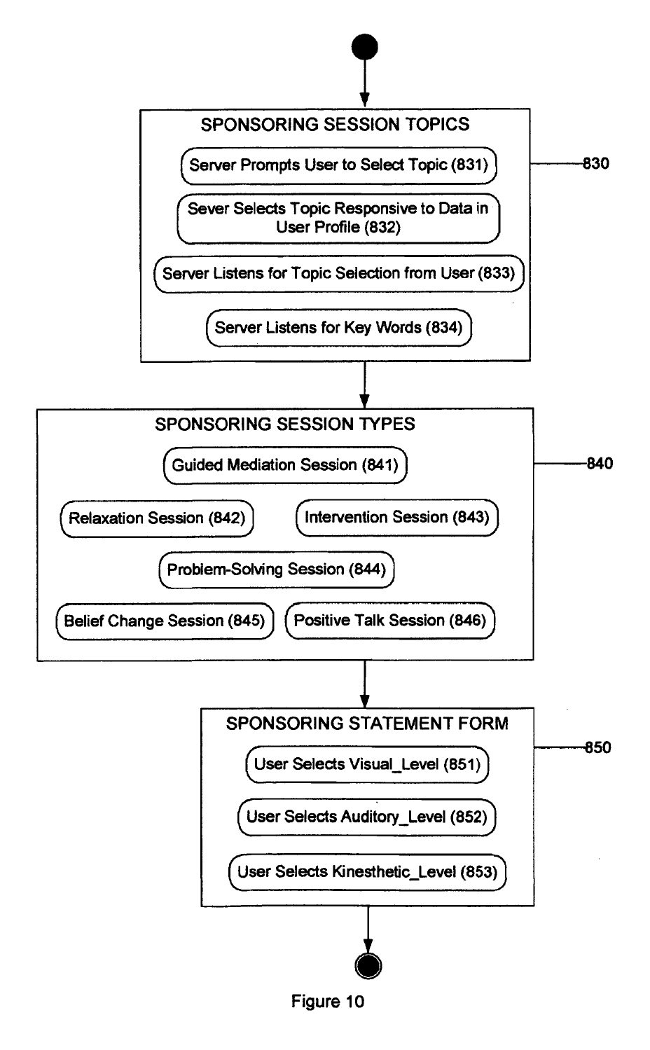

The virtual sponsoring control module 120 can include a user-driven virtual sponsoring session controller 122 to control the user-driven virtual sponsoring session based on the personal user profile of the one of the plurality of users and responsive to receiving, during the user-driven virtual sponsoring session, one or more user-driven virtual sponsoring session controls from the user computer 160 to be associated with the personal user profile of the one of the plurality of users. As perhaps is best illustrated in FIG. 10, the one or more virtual sponsoring session controls can include, for example, one or more virtual sponsoring topics 830, one or more virtual sponsoring session types 840, and one or more virtual sponsoring statement forms 850 to thereby allow the one of the plurality of users to modify the user-driven virtual sponsoring session by controlling for example, the topic of the user-driven virtual sponsoring session 830, the virtual sponsoring session type 840, and the virtual sponsoring statement form 850.

To control the virtual sponsoring session topic 830, for example, the user-driven virtual sponsoring session controller can prompt one of the plurality of users to select a virtual sponsoring session topic 831, and the user-driven virtual sponsoring session controller can receive a selection of a virtual sponsoring session topic 833 by listening and parsing key words provided by the one of the plurality of users 834. Alternatively, according to an exemplary embodiment of the present invention, the user-driven virtual sponsoring session controller can control the virtual sponsoring session topic by selecting a virtual sponsoring session topic responsive to the personal user profile of the one of the plurality of users 832. The user-driven virtual sponsoring session controller can additionally, according to an exemplary embodiment of the present invention, select a sponsoring session type responsive to one or more virtual sponsoring session types provided by the one of the plurality of users 840. The one or more virtual sponsoring session types can include, by way of example, a guided mediation session 841, a relaxation session 842, an intervention session 843, a problem-solving session 844, a belief change session 845, a positive talk session 846, a guided hypnosis session, and a guided self discovery and self improvement session. Moreover, the user-driven virtual sponsoring session controller can control the virtual sponsoring statement form responsive to selection by the one of the plurality of users of one or more virtual sponsoring statement forms 850. The one of the plurality of users, for example, can select the visual level 850, the auditory level 852, and the kinesthetic level 853 of the user-driven virtual sponsoring session.

The virtual sponsoring control module 120 can also include, for example, a user-designed virtual sponsor design controller 124 to control the design of the user-designed virtual sponsor based on the personal user profile of the one of the plurality of users and responsive to receiving during the user-driven virtual sponsoring session user input data. The user input data can include user input data modifying, for example, one or more physical characteristics of the user-designed virtual sponsor, one or more vocal characteristics of the user-designed virtual sponsor, or one or more personality characteristics of the user-designed virtual sponsor to thereby generate a modified user-designed virtual sponsor to be associated with the personal user profile of the one of the plurality of users. Additionally, the virtual sponsoring control module 120 can include a user-driven virtual sponsoring session terminator to terminate the user-driven virtual sponsoring session responsive to receiving a sponsoring session termination signal from the user computer 160 via the communications network 150.

The virtual sponsoring session module 130 can be, for instance, responsive to the virtual sponsoring session control module 120 and can have an initial statement presenter 132, a next statement presenter 134, a new statement creator 136, a virtual sponsoring session bookmarker 138, and a user action recommender 139. Moreover, the initial statement presenter 132, for instance, can present to the user computer 160 via the communications network 150, responsive to the virtual sponsoring control module 120, one or more virtual sponsoring statements selected from one or more of the plurality of lists of virtual sponsoring statements stored in the fourth database 148 and associated with at least one of the one or more user-driven virtual sponsoring session controls. Additionally, the next statement presenter 134 can present to the user computer 160 via the communications network 150, responsive to the virtual sponsoring control module 120 and user response data received from the user computer 160 via the communications network 150 responsive to each of the one or more presented virtual sponsoring statements, one or more virtual sponsoring statements selected from one or more of the plurality of lists of virtual sponsoring statements stored in the fourth database 148 and associated with at least one of the one or more user-driven virtual sponsoring session controls. Responsive to the user-driven virtual sponsoring session controller 120 and the user response data and based on one or more of the plurality of virtual sponsoring statement components stored in the fifth database 149, the new statement creator 136 can create, for example, one or more new virtual sponsoring statements different from the virtual sponsoring statements in each of the plurality of lists of virtual sponsoring statements. Such new virtual sponsoring statements can include, for example, rephrasing of user-derived statements in a question format, reframing user's negative statements, championing, congratulating, expressing statements of empathy and compassion, reminding the client of his past accomplishments, talents, abilities and the like. Moreover, the new statement creator, for instance, can categorize the created one or more new virtual sponsoring statements by topic, store the created one or more new virtual sponsoring statements in one or more of the plurality of lists of virtual sponsoring statements stored in the fourth database 148, and transmit to the user computer 160, via the communications network 150, the one or more new virtual sponsoring statements.

Advantageously, the virtual sponsoring session bookmarker 138 can bookmark, responsive to the user-driven virtual sponsoring session terminator 126, the user-driven virtual sponsoring session by creating a user-driven virtual sponsoring session snapshot and storing the user-driven virtual sponsoring snapshot in the third database 146. The user-driven virtual sponsoring snapshot can include, for example, the one or more virtual sponsoring statements most recently presented to the user and the user response data received responsive to the each of the most recently presented one or more virtual sponsoring statements. Also of benefit, the user action recommender 139 can recommend one or more actions for the one of the plurality of users to complete after termination of the user-driven virtual sponsoring session responsive to the virtual sponsoring control module 130.

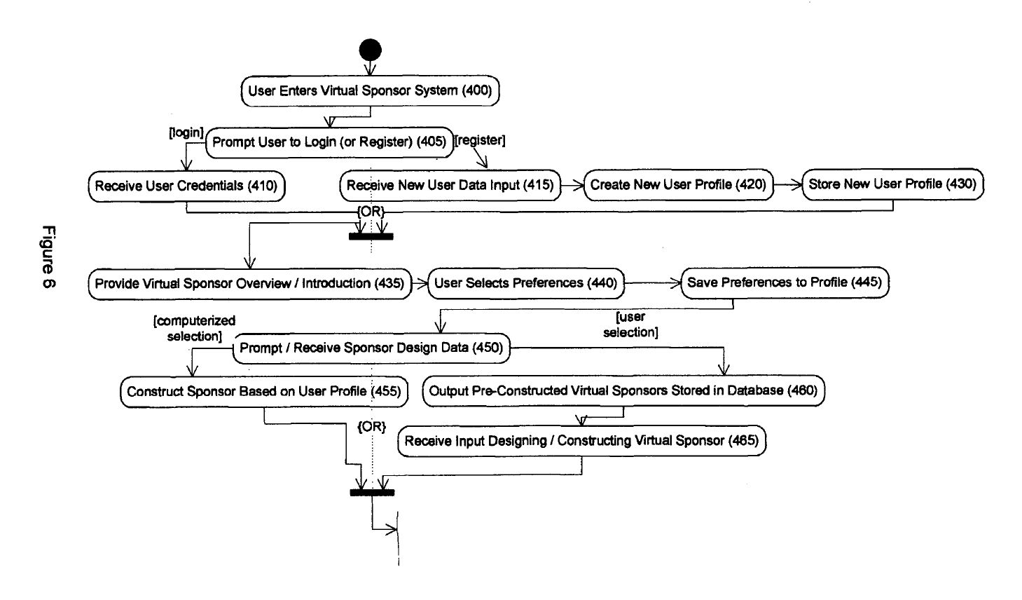

FIG. 5 illustrates a schematic database model diagram of the first 142, second 144, third 146, fourth 148, and fifth 149 databases according to an embodiment of the present invention. For instance, FIG. 5 illustrates the plurality of personal user profiles 325, each associated with one of the plurality of users, which are stored in the first database 142. Each of the plurality of personal user profiles 325 can include a plurality of personal user data and a set of virtual sponsoring preferences. The plurality of personal user data can include, for example, names, addresses, telephone numbers, social security numbers, driver license numbers, electronic mail addresses, fax numbers, mobile telephone numbers, post office boxes, job titles, employer names, employment background, professional background, educational information, spousal information, religious views, personality profiles, gender, sexual orientation, marital status, nationality, place of birth, family background, favorite color, favorite celebrity, level of knowledge regarding virtual sponsoring, emotional status, and one or more personal goals to be achieved as a result of one or more virtual sponsoring sessions. The set of virtual sponsoring preferences can include, for example, one or more preferred sponsoring session types 335 and one or more preferred sponsoring statement forms 350. Each user-driven virtual sponsoring session can include, for example, aspects of a guided mediation session, a relaxation session, an intervention session, a problem solving session, a personal belief change session, a positive talk session, a guided hypnosis session, a self discovery and self improvement session. Accordingly, the one or more preferred sponsoring session types 335 can be defined, for example, by data indicating a guided mediation level, a relaxation level, an intervention level, a problem solving level, a belief change level, a positive talk level, a guided hypnosis level and a self discovery and self improvement level.

Likewise, a user-driven virtual sponsoring session can query a user to determine the user's learning preference and can accordingly tailor a user-driven virtual sponsoring session to the each of the plurality of user's learning preferences. For example, some of the plurality of users may prefer to learn through visual stimulation, others prefer auditory stimulation, and still others respond best with tactile or kinesthetic stimulation. Thus, the one or more preferred sponsoring statement forms 350 can include elements of visual stimulation, auditory stimulation, and kinesthetic stimulation, and the one or more preferred sponsoring session forms 350 can be defined by data indicating a visual level, an auditory level, and a kinesthetic level. The visual, auditory, and kinesthetic learning style is provided by way of example only. Other learning styles, such as those indicated by the Sudbury Model of Democratic Education, and Myers Briggs Type Indicator, and the DISC assessment may be applied by the user-driven virtual sponsoring session generator 114 and the user-driven virtual sponsoring session controller 122 in order to generate a statement for presentation to one of the plurality of users.

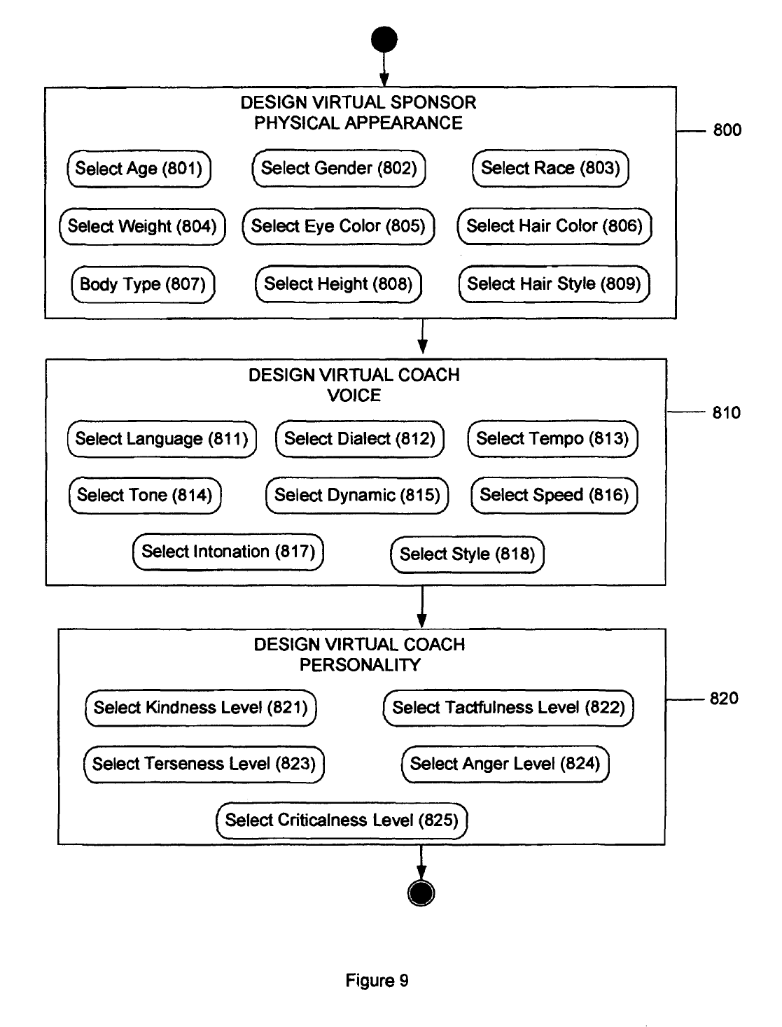

Also graphically illustrated by FIG. 5 and FIG. 9 is the second database 144 according to an embodiment of the present invention. The second database 144 includes a plurality of virtual sponsor data files, each of which is associated with one or more of the plurality of virtual sponsors. Each virtual sponsor data file, according to an embodiment of the present invention, for instance, can include virtual sponsor characteristics data generated by one or more of the plurality of users. The virtual sponsor characteristics data can include one or more physical characteristics of a virtual sponsor 305, one or more vocal characteristics of a virtual sponsor 310, and one or more personality characteristics of a virtual sponsor 315. The one or more physical characteristics of a virtual sponsor 305 can include, but is not limited to, age 801, gender 802, race 803, weight 804, eye color 805, hair color 806, body type 807 (i.e., athletic, skinny, overweight, fit, etc.), height 808, and hair style 809, body mass index, and whether the virtual coach wears glasses or contacts, as well as the name of the virtual coach. The one or more vocal characteristics of a virtual sponsor 310 can include, but is not limited to, language 811, dialect 812, tempo 813, tone 814, dynamic 815, speed 816, intonation 817, style 818 and breathing rate. Additionally, the one or more personality characteristics of a virtual sponsor 315 can include, but is not limited to, data indicating a level of kindness 821, a level of tactfulness 822, a level of terseness 823, a level of anger 824, and a level of criticalness 825. Moreover, the one or more personality characteristics of the virtual coach may include, according to exemplary embodiments of the present invention, personality traits related to any method of personality identification as known and understood by those skilled in the art, including but not limited to the DISC assessment, the Enneagram of Personality, the Four Temperaments, Humorism, the Keirsey Temperment Theory, the Myers-Briggs Type Indicator, Socionics, and the Type A/Type B personality theory. Furthermore, the virtual sponsor characteristics data can include one or more text-writing display characteristics that can be used in the absence of voice or visual characteristics. The one or more text-writing characteristics of a virtual sponsor can include, but is not limited to, words used, sentence construction, use of larger font, highlighting, bold text, underlined text, italicized text, and other text-based means to indicate emphasis, the use of concise or detailed statements, the frequency of interruption, and politeness level (e.g. frequency of using such words as sorry, please and the like).

FIG. 5 also graphically illustrates the third database 146 which includes a plurality of virtual sponsoring session data 330 according to an exemplary embodiment of the present invention. According to an embodiment of the present invention, the plurality of virtual sponsoring session data 330 can include data storing each user-driven virtual sponsoring session generated by the user-driven virtual sponsoring session generator 116, and each user-designed virtual sponsoring session can be defined, for example, by virtual sponsoring session preferences 335. The virtual sponsoring session preferences 335, according to an exemplary embodiment of the present invention, can be stored in the third database 146. Additionally, each of the plurality of virtual sponsoring session data 330 can include a user identification code that can be maintained as confidential and secure, identifying the one of the plurality of users associated with a particular virtual sponsoring session, a statement list identification code indicating one or more of the plurality of lists of virtual sponsoring statements that is most closely associated with the topic of the user-driven virtual sponsoring session selected by the one of the plurality of users, an identification code identifying the user-designed virtual sponsor associated with the particular user-driven virtual sponsoring session, a session type identification code identifying the user-driven virtual sponsoring session type selected by the one of the plurality of users, a plurality of saved session data associated with the particular user-driven virtual sponsoring session, and one or more identification codes identifying one or more related user-driven virtual sponsoring sessions.

Moreover, FIG. 5 graphically illustrates the fourth database 148 which includes a plurality of lists of virtual sponsor statements according to an exemplary embodiment of the present invention. Each of the plurality of lists of virtual sponsoring statements 340 stored in the fourth database 148 can be, for example, associated with one or more user driven virtual sponsoring session controls such as one or more virtual sponsoring topics 345, one or more virtual sponsoring session types 335, and one or more virtual sponsoring statement forms 350. The one or more virtual sponsoring session topics 345 can be represented, for example, by a topic keyword or a topic summary. Each respective one of the plurality of lists of virtual sponsoring statements 340 stored in the fourth database 148 can include an identification code identifying the topic associated with the respective one of the plurality of lists of virtual sponsoring statements 340, an identification code identifying the form of the virtual sponsoring statements included in the respective one of the plurality of lists of virtual sponsoring statements 340, and a plurality of virtual sponsoring statements. The fourth database 148 can also include a plurality of new virtual sponsoring statements 355 created by the new statement creator where such new virtual sponsoring statements 355 are different from the virtual sponsoring statements stored in each of the plurality of lists of virtual sponsoring statements 340. Such new virtual sponsoring statements 355 can be stored by statement components in the fourth database 148. The new virtual sponsoring statements 355 can also be categorized by one or more virtual sponsoring session controls and stored in the one or more of the plurality of lists of virtual sponsoring statements 340 stored in the fourth database 148.

FIG. 5 also graphically illustrates the fifth database 149 according to an exemplary embodiment of the present invention. The fifth database 149 can store, for example, a plurality of virtual sponsoring statement components 360. The plurality of virtual sponsoring statement components 360 stored in the fifth database 149 can include, for example, alphanumeric characters, non-alphanumeric characters, words, phrases, clauses, sentences, sets of sentences, or paragraphs. The alphanumeric characters can include, for example, any collection of Latin letters and Arabic digits and can be selected from, for example, the English alphabet, the French alphabet, the Spanish alphabet, the Italian alphabet, the Portuguese alphabet or any other alphabet using as its character set alphanumeric characters. The non-alphanumeric characters can include any characters not known or understood by those skilled in the art as alphanumeric characters and can be, for example, selected from Chinese Characters, Japanese Characters, or any other set of characters using non-alphanumeric characters. According to an exemplary embodiment of the present invention, the words can be of any length, the phrases, clauses, and sentences can include any number of words, and the set of sentences and paragraphs can include any number of sentences.

In addition to depicting graphically the content of each of the first 142, second 144, third 146, fourth 148, and fifth 149 databases according to an embodiment of the present invention, FIG. 5 graphically depicts an exemplary database architecture. The solid lines, each with an arrow on one end, illustrate an exemplary structure of associations between each of the five databases and each of the data tables stored within each of the five databases. Specifically, the particular data table connected to the tail end of a particular line includes an item of data that points to a second data table where such second data table is connected to the point end of the particular line. For instance, the data table storing the plurality of user profiles 325 in the first database 142 includes a preferred sponsor ID which references, or points to, the data table storing the plurality of virtual sponsor data files 320 in the second database 144. Accordingly, while the data table storing the plurality of user profiles 325 in the first database 142 does not directly house the associated virtual sponsor data file 320, which is stored in the second database 144, the two databases can be associated, for example, so that one or more personal user profiles 325 can be associated with the same virtual sponsor data file 320 without the need to repetitively store the same virtual sponsor data file 320 in each of the one or more personal user profiles 325.

Similarly, the data table storing the plurality of virtual sponsor data files 320 in the second database 144 includes a sponsor physical ID which references one or more physical characteristics of a virtual sponsor 305 stored in a data table in the second database 144, a sponsor vocal ID which references one or more vocal characteristics of a virtual sponsor 310 stored in a data table in the second database 144, and a sponsor personality ID which references one or more personality characteristics of a virtual sponsor 315 stored in a data table in the second database 144. Likewise, a data table storing the plurality of virtual sponsoring session data includes a user ID which references one or more of the plurality of user profiles stored in a data table 325 in the first database 132, a statement list ID which references the one or more of the plurality of lists of virtual sponsoring statement stored 340 stored in a data table in the fourth database 148, a sponsor ID which references one or more of the plurality of user-designed virtual sponsors 320 stored in a data table in the second database 144, and a session type ID which references one or more sponsoring session types 335 stored in a data table in the third database 146.

Additionally, the data table storing the plurality of lists of virtual sponsoring statements includes a topic ID which references one or more topic key words or topic summaries 345 stored in a data table in the fourth database 148, a statement form ID which references one or more sponsoring statement forms 350 stored in a data table in the fourth database 148, and a new statement ID which references one or more of a plurality of virtual sponsoring statements 355 stored in a datable in the fourth database 148. The data table storing the plurality of virtual sponsoring statements further includes one or more statement component set IDs which each reference a set of virtual sponsoring statement components 360 stored in a data table in the fifth database 149. The database architecture described with reference to FIG. 5 is only an example of the various architectures that can be employed according to embodiments of the present invention. Additionally, the above described database architecture can, for example, be implemented with respect to a user-driven virtual sponsoring system, or alternatively, the database architecture for example, can be used by a computer implemented method or a computer readable program product to facilitate an on-demand, user-driven, virtual sponsoring session for one or more user-selected topics through user-designed virtual sponsors.

According to an exemplary embodiment of the present invention, the virtual sponsoring session initialization module can further include, for example, a new user orientator. The new user orientator can be configured, for example, to perform several operations when one of the plurality of users of the user-driven virtual sponsoring system is a new user of the user-driven virtual sponsoring system. Specifically, the new user orientator can be configured to orient the one of the plurality of users to the user-driven virtual sponsoring system by providing a virtual sponsoring introduction. The virtual sponsoring introduction can, for instance, include an overview of the virtual sponsoring process, a description of one or more sponsoring session types, and a description of one or more sponsoring statement forms. Moreover, the new user orientator, according to an embodiment of the present invention, for example, can also be configured to collect, via the user computer 160 through the communications network 150, personal user data of the one of the plurality of users such as family background, educational background, professional background, and level of knowledge regarding virtual sponsoring. The new user orientator can be additionally configured, for example, to assign a user name and a password to the one of the plurality of users of the virtual sponsoring system.

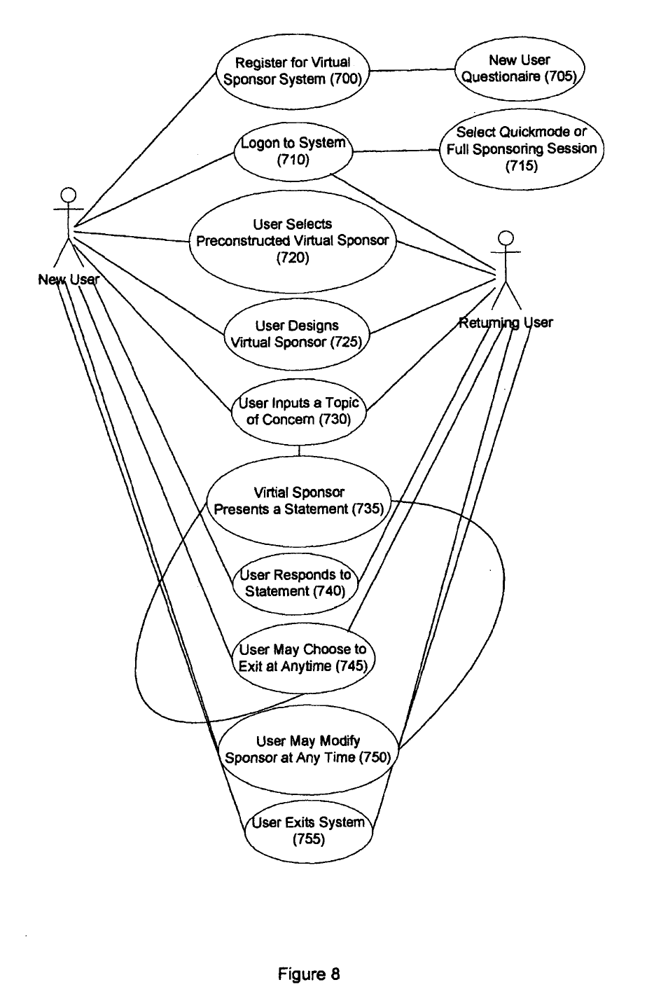

Accordingly, the virtual sponsoring system can, for example, interact with both new users and returning users, as is perhaps best illustrated in FIG. 8. Specifically, a returning user, that is, a user that has already undertaken one or more user-driven virtual sponsoring sessions can, for example, logon to the system and access a user-driven virtual sponsoring session 710, select the user's desired type of virtual sponsoring session 715, select a pre-designed default virtual sponsor 720, create a user-designed virtual sponsor 725, input a virtual sponsoring session topic 730, evaluate one or more virtual sponsoring statements 735, provide user response data responsive to each of the one or more virtual sponsoring statements 740, exit the user-driven virtual sponsoring session, at any time 745, 755, and modify the user-designed virtual sponsor 750. In addition to the various ways a returning user can interact with the virtual sponsoring system, a new user can, for example, register for the virtual sponsoring system to thereby create a personal user profile 700, and complete a new user questionnaire to thereby provide personal user data 705.

Additionally, according to an exemplary embodiment of the present invention as is depicted in FIG. 2, the output device 166 of the user computer 160 can include a graphical user interface device 168 and a user interface input device 169. The graphical user interface device can include, for example, a CRT monitor, a LCD monitor, a LED monitor, a plasma monitor, an OLED screen, a television, a DLP monitor, a video projection, a three-dimensional projection, a holograph, a touch screen or any other type of user interface which allows the one of the plurality of users to interact with the user computer 160 using images as is known and understood by those skilled in the art. Additionally, the user interface input device 169 can include, for instance, a keyboard, a mouse, a touch screen, a tablet computer, a handwriting recognition enabled tablet computer, voice recognition software, gesture recognition software, facial expression recognition software or a biofeedback device.

The second database 144, according to an exemplary embodiment of the present invention, can include one or more virtual sponsor data files defining one or more pre-designed default virtual sponsors. The one or more pre-designed default virtual sponsors can be, for instance, pre-installed with the user-driven virtual sponsoring system such that one or more pre-designed default virtual sponsors can be associated with one of the plurality of users of the user-driven virtual sponsoring system if the one of the plurality of users does not choose to create a user-designed virtual sponsor. Additionally, the user can choose to select one or more pre-designed default virtual sponsors to be associated with the personal user profile of the one of the plurality of users. Specifically, according to an exemplary embodiment of the present invention, the user-designed virtual sponsor generator can be further configured to display, via the graphical user interface device 168 of the user computer 160 through the communications network 150, one or more of the one or more pre-designed default virtual sponsors. The user-designed virtual sponsor generator can, for example, receive user input data from the user interface device 169 of the user computer 160 via the communications network 150 selecting one of the one or more pre-designed virtual sponsors. Additionally, the user-designed virtual sponsor generator can, for instance, receive user input data from the user interface device 169 of the user computer 160 via the communications network 150 modifying, for example, physical characteristics of the selected one of the one or more pre-designed default virtual sponsors, vocal characteristics of the selected one of the one or more pre-designed default virtual sponsors, and personality characteristics of the selected one of the one or more pre-designed default virtual sponsors. Responsive to the user input data received from the user interface input device 169 of the user computer 160 via the communications network 150, the user-designed virtual sponsor generator can, according to an exemplary embodiment of the present invention, generate a user-designed virtual sponsor to be stored in the second database 144 and associated with the personal user profile of the one of the plurality of users from the collective combination of the selected one of the one or more pre-designed default virtual sponsors and the modified physical, vocal, and personality characteristics of the one of the one or more pre-designed default virtual sponsors.

Also according to an embodiment of the present invention, the virtual sponsoring control module 120 can further include a user profile updater to update the personal user profile of the one of the plurality of users responsive to receiving during the user-driven virtual sponsoring session, user profile update input data from the one of the plurality of users via the user computer 160 through the communications network 150. The user profile update input data can include, for instance, personal user data, one or more preferred sponsoring session types, and one or more preferred sponsoring statement forms. Additionally, according to an embodiment of the present invention, the one or more physical characteristics of a virtual sponsor can include, but is not limited to, age, gender, race, height, weight, eye color, hair color, hair style and name of the virtual sponsor. The one or more vocal characteristics of a virtual sponsor can include, but is not limited to, language, dialect, intonation, speed, tempo, tone and breathing rate. The one or more personality characteristics of a virtual sponsor can include, but is not limited to, kindness level, tactfulness level, anger level, criticism level, and terseness level. Additionally, the set of virtual sponsoring session preferences can include, for example, a preferred address, a preferred sponsoring statement form, and a preferred sponsoring session type. Also according to an exemplary embodiment of the present invention, the sponsoring statement forms can be defined, in part, by one or more of: a visual statement level, an auditory statement level, and a kinesthetic statement level. Moreover the sponsoring session types can be defined, in part, by one or more of: a guided mediation level, a relaxation level, an intervention level, a problem solving level, a belief change level, a positive talk level, a guided hypnosis level and a self discovery and self improvement level.

According to an embodiment of the present invention, the one or more lists of virtual sponsoring statements can be, for example, a finite list of sequentially ordered statements each identifiable by a statement identifier. Beneficially, the snapshot of current sponsoring data can include a virtual sponsoring session progress indicator indicating progress made by the one of the plurality of users through each of the one or more of the plurality of lists of virtual sponsoring statements selected by one or both of the initial statement presenter and the next statement presenter. Additionally, the progress indicator can indicate the progress of the one of the plurality of users through each of the one or more of the plurality of lists of virtual sponsoring statements by providing to the one of the plurality of users, for instance, the number of statements in each of the one or more of the plurality of lists of virtual sponsoring statements that have been presented to the one of the plurality of users by one or both of the initial statement presenter or the next statement presenter, the number of statements in each of the one or more of the plurality of lists of virtual sponsoring statements that have not been presented to the one of the plurality of users by one or both of the initial statement presenter or the next statement presenter, and one or more statement identifiers identifying the virtual sponsoring statement from each of the one or more of the plurality of lists most recently presented to the one of the plurality of users by either the initial statement presenter or the next statement presenter. Accordingly, the virtual sponsoring session bookmarker 138 can be further configured to associate the user-driven virtual sponsoring session snapshot with the personal user profile of the one of the plurality of users to thereby update the personal user profile of the one of the plurality of users. The user-driven virtual sponsoring session snapshot can include, for instance, personal user data, one or more preferred sponsoring session types, and one or more preferred sponsoring statement forms.

The virtual sponsoring session initialization module 110 can further include, according to an exemplary embodiment of the present invention, a virtual sponsoring session goal determiner. The virtual sponsoring session goal determiner can, for example, determine one or more virtual sponsoring session goals of the one of the plurality of users by analyzing user input data received from the user computer 160 via the communications network 150 and can determine the value of the one or more virtual sponsoring session goals of the one of the plurality of users by analyzing user input data received from the user computer 160 via the communications network 150. Additionally, the virtual sponsoring session goal determiner can determine one or more desired outcomes, if at least one of the one or more virtual sponsoring session goals of the one of the plurality of users is achieved during the virtual sponsoring session, by analyzing user input data received from the user computer 160 via the communications network 150. Accordingly, the virtual sponsoring session goal determiner can determine, for example: one or more benchmarks to measure the achievement of the one or more virtual sponsoring goals of the one of the plurality of users; one or more positive or negative consequences of achieving the at least one of the one or more virtual sponsoring session goals of the one of the plurality of users; and one or more long-term effects of achieving the at least one of the one or more virtual sponsoring session goals of the one of the plurality of users. Additionally, the virtual sponsoring session goal determiner can determine one or more resources to assist the one of the plurality of users to achieve at least one of the one or more virtual sponsoring session goals of the one of the plurality of users, the one or more resources being selected from the list that includes, for example, knowledge resources, personal resources, professional resources, employment resources, and educational resources.

According to an embodiment of the invention, the virtual sponsoring session module can further include a virtual sponsoring session transcript generator. The virtual sponsoring session transcript generator can, for example, record transcripts of the virtual sponsoring statements and corresponding user responses in each virtual sponsoring session and transmit the transcripts to the user interface device via the communication network in order for the one of the plurality of users to review his or her virtual sponsoring session.

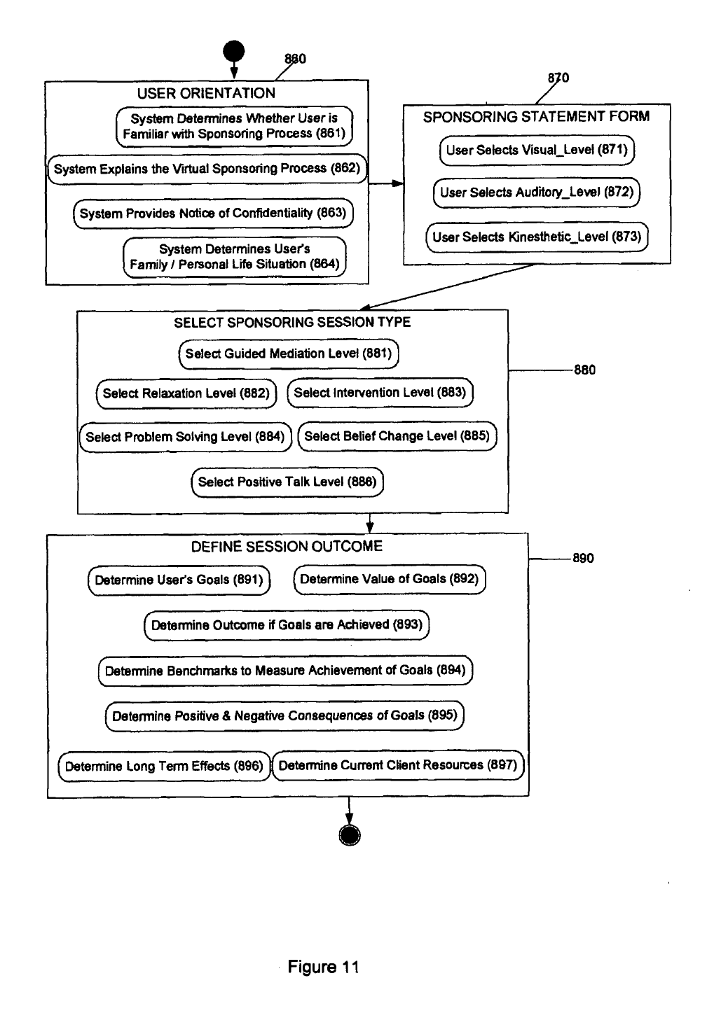

In sum, as is perhaps best illustrated in FIG. 11, the virtual sponsoring initialization module can, for example, orient one of the plurality of users to the user-driven virtual sponsoring system 860 by determining whether the one of the plurality of users is familiar with the virtual sponsoring process 861, by explaining the virtual sponsoring process to the one of the plurality of users 862, by providing a notice of confidentiality to the one of the plurality of users 863, and by collecting personal user data of the of the one of the plurality of users, including, but not limited to, family background, educational background, professional background, and level of knowledge regarding virtual sponsoring 864. Moreover, the virtual sponsoring initialization module can, for example, receive from the one of the plurality of users a set of virtual sponsoring session preferences to be associated with the personal user profile of the one of the plurality of users. The set of virtual sponsoring preferences can include one or more preferred sponsoring statement forms 870 and one or more preferred sponsoring session types 880. Additionally, the virtual sponsoring initialization module can define the desired outcome of the user-driven virtual sponsoring session 890 by determining the goals of the one of the plurality of users 891, determining the value of the such goals 892, determining the outcome if such goals are achieved by the one of the plurality of users 893, determining benchmarks to measure the achievement of such goals by the one of the plurality of users 894, determining the positive and negative consequences of achieving such goals 895, determining the long-term effects of the achievement by the one of the plurality of users of such goals 896, and determining the available resources of the one of the plurality of users needed to achieve such goals 897.

As illustrated in FIGS. 1-4, exemplary embodiments of the present invention also include a system to facilitate an on-demand, user-driven, virtual sponsoring session for one or more user-selected topics through user-designed virtual sponsors. The system, for example, can include a virtual sponsor computer 100 having at least a processor 102, a memory 106, and a database 140 and positioned to facilitate a user-driven virtual sponsoring session for one of a plurality of users. Additionally, the system can include a first computer readable program product 110 stored in a tangible computer medium 108 that includes instructions that, when executed by the virtual sponsor computer 100, cause the virtual sponsor computer to perform various operations. The instructions on the first computer readable program product 110 can, for instance, include those that when executed cause the virtual sponsor computer 100 to perform the operation of generating 114, responsive to a personal user profile derived from a plurality of personal user data associated with the one of the plurality of users and received from a user interface device 160, 170, 200, 210, 220 a user-designed virtual sponsor to be associated with the personal user profile. The operation of generating the user-designed virtual sponsor 114 can also be responsive to virtual sponsor characteristics data generated by selection, by the one of the plurality of users, of one or more characteristics of a virtual sponsor, so that a collective combination of the selected one or more characteristics of a virtual sponsor generate a user-designed virtual sponsor. The instructions on the first computer readable program product 110 can, for example, can further include those that when executed by the virtual sponsor computer 100 cause the virtual sponsor computer 100 to perform the operation of generating a user-driven virtual sponsoring session 116 responsive to generating the user-designed virtual sponsor 114 and responsive to receiving from the user interface device the set of virtual sponsoring session preferences to be associated with the personal user profile of the one of the plurality of users. The user-driven virtual sponsoring session can be, for example, based on the personal user profile of the one of the plurality of users, the user-designed virtual sponsor designed by the one of the plurality of users, and the set of virtual sponsoring preferences.

According to an exemplary embodiment of the present invention, the system can also include a second computer readable program product 120 stored in a tangible computer medium 108 and including instructions that, when executed by the computer 100, cause the virtual sponsor computer 100 to perform the operation of controlling the user-driven virtual sponsoring session based on the personal user profile of the one of the plurality of users and responsive to receiving during the user-driven virtual sponsoring session one or more user-driven virtual sponsoring session controls from the user interface device 160, 170, 200, 210, 220 to be associated with the personal user profile of the one of the plurality of users. Moreover, the second computer readable program product 120 stored in the tangible computer medium 108 can further include instructions that when executed by the virtual sponsor computer 100 cause the virtual sponsor computer 100 to perform the operation of controlling the design of the user-designed virtual sponsor based on the personal user profile of the one of the plurality of users and, responsive to receiving during the user-driven virtual sponsoring session user input data, modifying one or more characteristics of the user-designed virtual sponsor to thereby generate a modified user-designed virtual sponsor to be associated with the personal user profile of the one of the plurality of users.

Such a system according to an embodiment of the present invention can additionally include a third computer readable program product 130 stored in a tangible computer medium 108 that includes instructions that when executed by the virtual sponsor computer 100 cause the virtual sponsor computer 100 to perform the operation of presenting to the user interface device 160, 170, 200, 210, 220, responsive to the second computer readable program product 120, one or more virtual sponsoring statements selected from one or more of a plurality of lists of virtual sponsoring statements associated with at least one of the one or more user-driven virtual sponsoring session controls and stored in the database 140. The third computer readable program product 130 can also include, for example, instructions that when executed by the virtual sponsor computer 100 cause the virtual sponsor computer 100 to perform the operation of presenting to the user interface device 160, 170, 200, 210, 220, responsive to the second computer readable program product 120 and user response data received from the user interface device 160, 170, 200, 210, 220 responsive to each of the one or more presented virtual sponsoring statements, one or more virtual sponsoring statements selected from one or more of the plurality of lists of virtual sponsoring statements associated with at least one of the one or more user-driven virtual sponsoring session controls and stored in the database. Specifically, the one or more virtual sponsoring statements can be, for example, selected from one or more of the plurality of lists of virtual sponsoring statements associated with at least one of the one or more user-driven virtual sponsoring session controls and stored in the database 140. Moreover, according to an exemplary embodiment of the present invention, the third computer readable program product 130 can also include, for example, instructions that when executed by the virtual sponsor computer 100 cause the virtual sponsor computer 100 to perform the operations of creating, responsive to the second computer readable program product 120 and the user response data and based on one or more of a plurality of virtual sponsoring statement components stored in the database 140, one or more new virtual sponsoring statements different from the virtual sponsoring statements in each of the plurality of lists of virtual sponsoring statements stored in the database 140, and transmitting to the user interface device 160, 170, 200, 210, 220 the one or more new virtual sponsoring statements.

As is perhaps best illustrated by FIG. 1, the user interface device 160, 170, 200, 210, 220 can include a graphical user interface device 168, a personal computer 160, 200, a telephonic device 210, a mobile device 220, a personal digital assistant (“PDA”) 170, or a video game console. The personal computer 160, 200 can include a desktop computer, a laptop computer, a tablet computer, a micro computer, a mini computer, a notebook computer, an ultra-mobile personal computer, or any other general-purpose computer intended to be operated directly by an end user with no intervening computer operator as is known and understood by those skilled in the art. The computer may include, for instance, a keyboard, a mouse, a graphical user interface device, a microphone, electronic speakers, a modem, a LAN card, a computer graphics card, a printer, a scanner, a disk drive, a tape drive, a camera, a Wi-Fi® (Wi-Fi Alliance Corporation California, Austin, Tex.) card, a PCMCIA card, or any other peripheral device as is known and understood by those skilled in the art. The telephonic device 210 can include, by way of example only, a telephone, a wireless telephone, a computer voice modem, a voice-over-TCP/IP telephone, and any other telecommunications device that facilitates voice communication over distances. The mobile device 220 can include, but is not limited to, a cellphone device, a handheld device, a handheld computer, a palmtop, a handheld device, or any other mobile computing device. The mobile device 220 can also include, for instance, a display screen with a touch input user interface or a miniature keyboard, or a touch-screen interface. The PDA 170, for example, can include a processor 172, memory 174, an input device 176, and an output device 176. Additionally, the PDA, for instance, can include a palmtop computer, a smartphone, a palm device, a portable media player, a Wi-Fi®-enabled device (Wi-Fi Alliance Corporation California, Austin, Tex.), a global positioning system device, or any other handheld computing device now or hereinafter developed as is known and understood by those skilled in the art. The video game console can include any device or interactive entertainment computer or modified computer system that produces a video display signal that can be used with a display device to display a video game now or hereinafter developed as is known and understood by those skilled in the art. Such devices can include, by way of example only, Xbox® (Microsoft Corp., Redmond, Wash.), PlayStation® (Sony Computer Entertainment, Tokyo, Japan), Wii® (Nintendo of America, Inc., Redmond, Wash.), GameBoy® (Nintendo of America, Redmond, Wash.), GameCube® (Nintendo of America, Redmond, Wash.), handheld video game consoles, and PDA devices.

According to an embodiment of the present invention, for example, the database 140 can include a first 142, second 144, third 146, fourth 148, and fifth 149 databases, the first database including a plurality of user profiles each associated with one of a plurality of users, the second database including a plurality of virtual sponsor data files, the third database including a plurality of virtual sponsoring session data, the fourth database including a plurality of lists of virtual sponsor statements, each associated with at least one or more user-driven virtual sponsoring session controls, and the fifth database including a plurality of virtual sponsoring statement components. Moreover, the first computer readable program product 110 can further include, for example, instructions that when executed by the virtual sponsor computer 100 cause the virtual sponsor computer 100 to perform the operations of storing the personal user profile associated with the one of the plurality of users and received from the user interface device 160, 170, 200, 210, 220 in the first database 142, storing the user-designed virtual sponsor generated responsive to the personal user profile associated with the one of the plurality of users in the second database 144, and storing the user-driven virtual sponsoring session generated responsive to generating the user-designed virtual sponsor and responsive to receiving from the user interface device 160, 170, 200, 210, 220 the set of virtual sponsoring preferences in the third database 146. Additionally, the third computer program product 130 can further include instructions that, for example, when executed by the virtual sponsor computer 100 cause the virtual sponsor computer to perform the operations of categorizing the one or more new virtual sponsoring statements, created responsive to the second computer program product 120 and the user response data, by topic, and storing the one or more new virtual sponsoring statements created responsive to the second computer readable program product 120 and the user response data in the fourth database 148.

Beneficially, the one or more characteristics of a virtual sponsor can include, for instance, one or more physical characteristics of a virtual sponsor, one or more vocal characteristics of a virtual sponsor, and one or more personality characteristics of a virtual sponsor. The set of virtual sponsoring session preferences can include, by way of example, one or more preferred session types and one or more preferred sponsoring statement forms. The one or more user-driven virtual sponsoring session controls can include, for instance, one or more virtual sponsoring session topics, one or more virtual sponsoring session types, and one or more virtual sponsoring statement forms. Additionally, the one or more characteristics of the user-designed virtual sponsor can include one or more physical characteristics of the user-designed virtual sponsor, one or more vocal characteristics of the user-designed virtual sponsor, and one or more personality characteristics of the user-designed virtual sponsor.

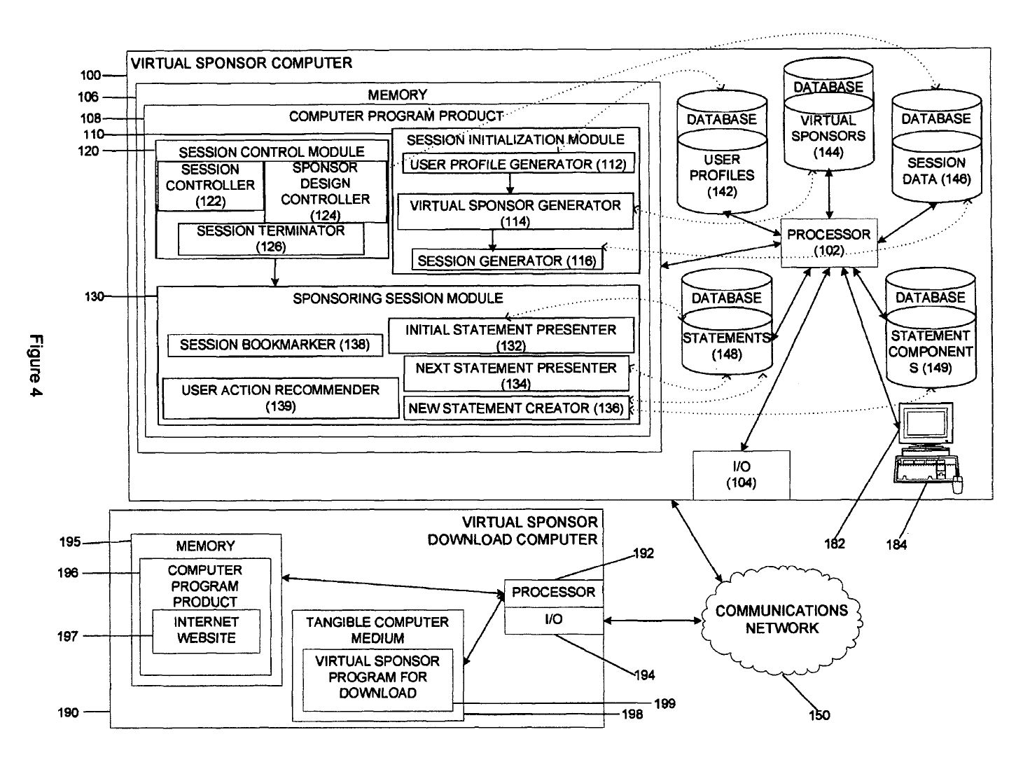

As is perhaps best illustrated in FIG. 3, the user interface device 160, 170, 200, 210, 220 can be, for instance, connected to the virtual sponsor computer 100. In this exemplary embodiment, the virtual sponsor computer 100 can further include a user interface input device 180, 184 and a graphical user interface device 182. Alternatively, according to an exemplary embodiment of the present invention, the user interface device 160, 170, 200, 210, 220 can be positioned remote from the virtual sponsor computer 100 and in communication with the virtual sponsor computer 100 via a communications network 150.

According to an exemplary embodiment of the present invention, the third computer readable program product 130 can further include instructions that, when executed by the virtual sponsor computer 100, cause the virtual sponsor computer to perform the operations of bookmarking, responsive to receiving a sponsoring session termination signal from the user interface device 160, 170, 200, 210, 220, the user-driven virtual sponsoring session by creating a user-driven virtual sponsoring session snapshot, and recommending, responsive to receiving the sponsoring session termination signal from the remote user interface device 160, 170, 200, 210, 220 via the communications network 150, one or more actions for the one of the plurality of users to complete after termination of the user-driven virtual sponsoring session. The user-driven virtual sponsoring snapshot, for example, can include the one or more virtual sponsoring statements most recently presented to the user and the user response data received responsive to the each of the most recently presented one or more virtual sponsoring statements.

Also according to an embodiment of the present invention, for example, the first computer readable program product 110 can further include instructions that, when executed by the virtual sponsor computer 100, cause the virtual sponsor computer 100 to perform, when the one of the plurality of users is a new user of the user-driven virtual sponsoring system, the operations of orienting the one of the plurality of users to the user-driven virtual sponsoring system by providing a virtual sponsoring introduction, collecting, via the user interface device 160, 170, 200, 210, 220, personal user data of the one of the plurality of users, and assigning a user name and a password to the one of the plurality of users of the virtual sponsoring system. The virtual sponsoring introduction can, for instance, include an overview of the virtual sponsoring process, a description of one or more sponsoring session types, and a description of one or more sponsoring statement forms.

Additionally, the second database 144 can include, for example, one or more virtual sponsor data files defining one or more pre-designed default virtual sponsors. Accordingly, the computer readable instructions that, when executed by the virtual sponsor computer 100, cause the virtual sponsor computer 100 to perform the operation of generating a user-designed virtual sponsor further include instructions that, when executed by the virtual sponsor computer 100, cause the virtual sponsor computer 100 to perform the operations of displaying, via the graphical user interface device 168 of the user interface device 160, 170, 200, 210, 220, one or more of the one or more pre-designed default virtual sponsors, and generating a user-designed virtual sponsor to be stored in the second database 144 and associated with the personal user profile of the one of the plurality of users responsive to user input data received from the user interface device 160, 170, 200, 210, 220 selecting one of the one or more pre-designed default virtual sponsors and user input data modifying one or more of: physical characteristics of the selected one of the one or more pre-designed default virtual sponsors, vocal characteristics of the selected one of the one or more pre-designed default virtual sponsors, and personality characteristics of the selected one of the one or more pre-designed default virtual sponsors so that a collective combination of the selected one of the one or more pre-designed default virtual sponsors and the modified physical, vocal, and personality characteristics of the one of the one or more pre-designed virtual sponsors generate a user-designed virtual sponsor.

Furthermore, according to an exemplary embodiment of the present invention, the second computer readable program product 120 can further include, for example, instructions that when executed by the virtual sponsor computer 100 cause the virtual sponsor computer 100 to perform the operation of updating the personal user profile of the one of the plurality of users responsive to receiving during the user-driven virtual sponsoring session, user profile update input data from the one of the plurality of users via the user interface device 160, 170, 200, 210, 220. Particularly, the user profile update input data can include, for example, personal user data, one or more preferred sponsoring session types, and one or more preferred sponsoring statement forms.

Advantageously, each of the one or more lists of virtual sponsoring statements can be a finite list of ordered statements each identifiable by a statement identifier. Additionally, the user-driven virtual sponsoring session snapshot can include, for example, a virtual sponsoring session progress indicator indicating progress made by the one of the plurality of users through each of the one or more of the plurality of lists of virtual sponsoring statements associated with one or more of the one or more virtual sponsoring statements presented to the user interface device 160, 170, 200, 210, 220 during the user-driven virtual sponsoring session. The progress indicator can include, according to an exemplary embodiment of the present invention, one or more statement identifiers identifying the virtual sponsoring statement from each of the one or more of the plurality of lists of virtual sponsoring statements most recently presented to the one of the plurality of users, to thereby indicate the progress of the one of the plurality of users through each of the selected one or more of the plurality of lists of virtual sponsoring statements. Moreover, the third computer readable program product 130 can further include instructions that when executed by the virtual sponsor computer 100 cause the virtual sponsor computer 100 to perform the operation of associating the user-driven virtual sponsoring session snapshot with the personal user profile of the one of the plurality of users to thereby update the personal user profile of the one of the plurality of users.

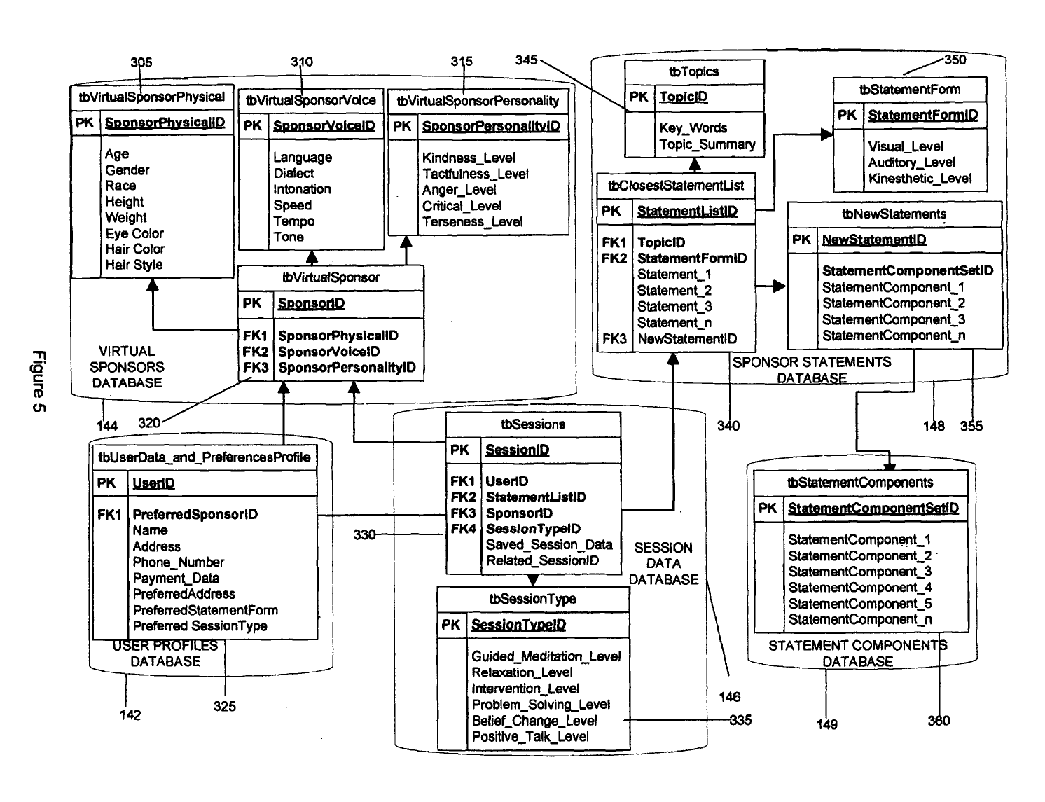

As is perhaps best illustrated in FIG. 4, the system according to an embodiment of the present invention can further include a virtual sponsor download computer 190 having at least a processor 192, an input device 194, an output device 194, a tangible computer medium 198 storing a virtual sponsor computer readable program product 199 for download by a user, and a memory 195. The memory of the virtual sponsor download computer can further include an Internet website 197 to facilitate the downloading of the virtual sponsor computer readable program product 199 by the user for use on a user computer 200 via the communications network 150. The virtual sponsor computer readable program product 199 can be, for instance, installed on the user computer for use by the user. According to an exemplary embodiment of the present invention, the user computer can be remote from, and not in communication with, the virtual sponsor download computer 190. The term download or downloading, as used herein, refers to any transfer of data, including both sending and receiving of data, between two computers including but not limited to, connections via direct cable, wireless, infrared, Bluetooth® (Bluetooth Sig., Inc., Bellview, Wash.), Wi-Fi® (Wi-Fi Alliance Corporation California, Austin, Tex.), telecommunications network, communications network, or the Internet. The communications network can include a telephony network, a wireline network, a wireless network, a wide area network, an infrared network, a radio-frequency network, an optical network, or any other communications network now or hereinafter created as is known and understood by those skilled in the art.

Note, the virtual sponsor computer 100, the user computer 160, 200, and the virtual sponsor download computer 190, shown schematically in FIGS. 1-4, each represent a computer or computer cluster or computer farm and are not limited to any individual physical computers. The number of computers along with associated storage capacity and their architecture and configuration can be increased based on usage, demand, and capacity requirements for the system. Also note, the memory 106, 162, 174, 195, 206 can include volatile and nonvolatile memory known to those skilled in the art including, for example, RAM, ROM, and magnetic or optical disks, just to name a few. Additionally, examples of tangible computer medium 108 include but are not limited to: nonvolatile hard-coded type media such as read-only memories (ROMs), CD-ROMs, and DVD-ROMs, or erasable, electrically programmable read-only memories (EEPROMs), recordable type media such as floppy disks, hard disk drives, solid state disk drives, hard disk RAIDs, direct attached storage devices, CD-R/RWs, DVD-RAMs, DVD-R/RWs, DVD+R/RWs, flash drives, memory sticks, HD-DVDs, mini disks, laser disks, Blu-ray® (Blu-ray, Inc., Essex. CT) disks, and other newer types of memories, and transmission type media such as digital and analog communication links as are known and understood by those skilled in the art. Note additionally, the processor 102, 164, 172, 192, 204 is not limited to any single processor or processor type and can include any number of central processing units, microprocessors, graphics processing units, digital signal processors, network processors, coprocessors, data processors, audio processors, and any other electronic circuits that can evaluate computer readable instructions as is known and understood to those skilled in the art.

In another exemplary embodiment of the present invention, the virtual sponsoring session computer readable program can be used in a co-coaching session. Co-coaching is a structured practice of mutual exchange of coaching support among peers and comprises a range of practices that includes, but is not limited to, a plurality of users, each of whom take turns acting as a coach in a session. The computer readable program can be run on an Internet website for use by one or more of a plurality of users. Each of the plurality of users that act as the coach can access the plurality of lists of virtual sponsor statements, each associated with at least one of one or more user-driven virtual sponsoring session controls and the plurality of virtual sponsoring statement components to be responsive to user response data that is generated by the each of the plurality of users that act as the user in need of the co-coaching session. The computer readable program can guide the each of the plurality of users that act as the coach to a correct type of sponsoring session statements in response to the user-selected topic. Furthermore, the co-coaching sessions can serve as a method by which human coaches record and store information about their clients, including, but not limited, to personal preferences, language style, values, likes and dislikes. According to an embodiment of the present invention, this type of co-coaching can be performed on the virtual sponsor computer, the virtual sponsor download computer, the user computer, a computer or website that has access to the virtual sponsoring session computer readable program, various Internet chat rooms, and chatting and other social interaction websites and can, for example, be implemented as a character or avatar in the social interaction websites by providing access to the computer readable program. Users can select to activate the computer readable program and then be able to select various personalization options including but not limited to frequency of help, way of communication help (e.g. text, voice, graphical interface, topic, coaching proficiency level, number of questions, statements or action suggested to select from for the next step.

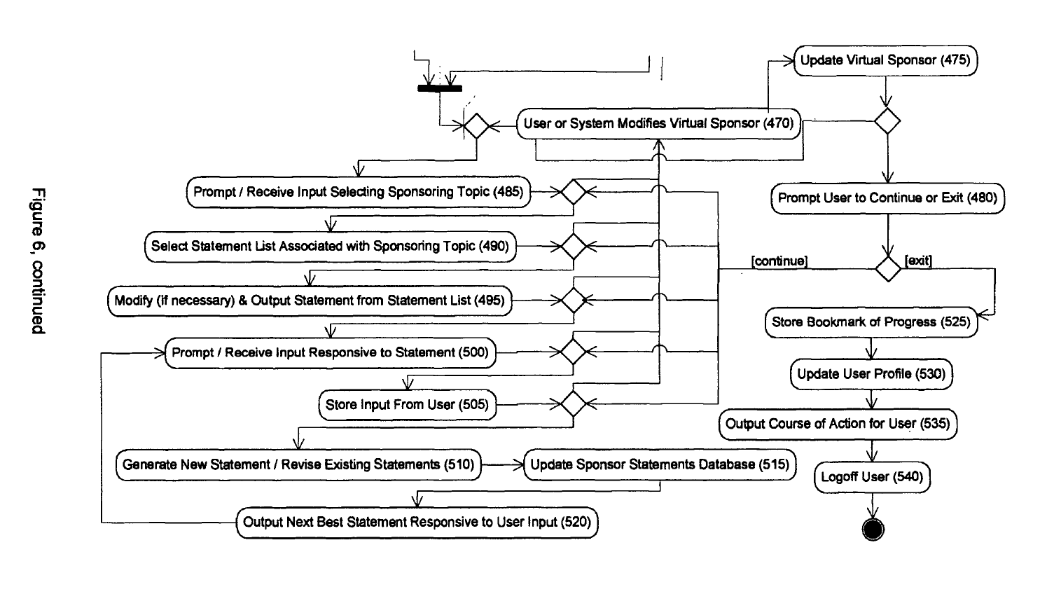

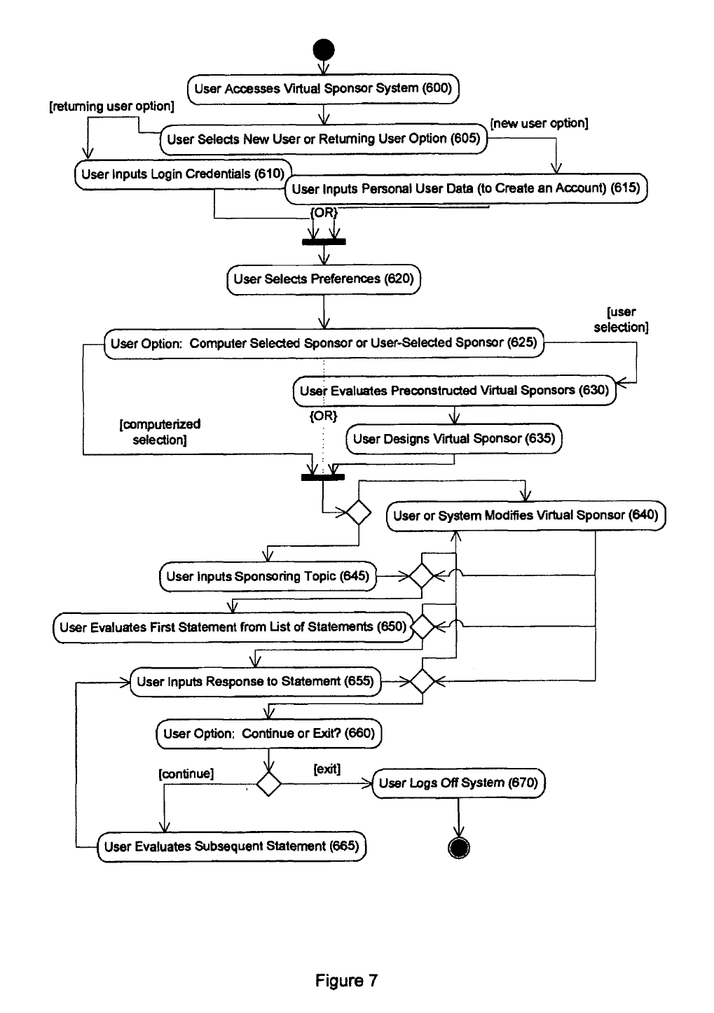

Exemplary embodiments of the present invention can also include a computer implemented method to facilitate an on-demand, user-driven, virtual sponsoring session for one or more user-selected topics through user-designed virtual sponsors. As illustrated in FIG. 6 and FIG. 7, such a computer implemented method can include the step of generating, via a computer, a personal user profile 420, derived from a plurality of personal user data received from a remote user interface device via a communications network 415 and associated with the one of the plurality of users, to be stored in the personal user profile stored in a first database 430. Responsive to the user profile of the one of the plurality of users, the computer implemented method can further include, for example, the step of generating, via the computer, a user-designed virtual sponsor 465 to be stored in a second database and associated with the personal user profile of the one of the plurality of users. The operation of generating the user-designed virtual sponsor 465 can, for instance, be responsive to virtual sponsor characteristics data 450 generated by selection, by the one of the plurality of users, of one or more physical characteristics of a virtual sponsor, one or more vocal characteristics of a virtual sponsor, and one or more personality characteristics of a virtual sponsor so that a collective combination of the selected one or more physical characteristics of a virtual sponsor, one or more vocal characteristics of a virtual sponsor, and one or more personality characteristics of a virtual sponsor generate a user-designed virtual sponsor.

Furthermore, the computer implemented method can include, for example, the step of generating, via the computer, a user-driven virtual sponsoring session 445 responsive to generating the user-designed virtual sponsor and responsive to receiving from the remote user interface device via the communications network the set of virtual sponsoring session preferences 440 to be associated with the personal user profile of the one of the plurality of users and stored in a third database. The set of virtual sponsoring session preferences can include, for instance, one or more preferred sponsoring session types and one or more preferred sponsoring statement forms. The user-driven virtual sponsoring session, for example, can be based on the personal user profile of the one of the plurality of users, the user-designed virtual sponsor designed by the one of the plurality of users, and the set of virtual sponsoring preferences.

Beneficially, the computer implemented method according to an embodiment of the present invention includes the steps of controlling, via the computer, the user-driven virtual sponsoring session based on the personal user profile of the one of the plurality of users and responsive to receiving during the user-driven virtual sponsoring session one or more user-driven virtual sponsoring session controls 485 from the remote user interface device to be associated with the personal user profile of the one of the plurality of users, and controlling via the computer, the design of the user-designed virtual sponsor 470, 475 based on the personal user profile of the one of the plurality of users and responsive to receiving, during the user-driven virtual sponsoring session, user input data. The one or more user-driven virtual sponsoring session controls can include user input data modifying, for example, one or more virtual sponsoring topics 485, one or more virtual sponsoring session types, or one or more virtual sponsoring statement forms, such that the one of the plurality of users can modify the user-driven virtual sponsoring session by controlling, for example, the topic of the user-driven virtual sponsoring session 485, the virtual sponsoring session type, or the virtual sponsoring statement form. Additionally, the virtual sponsoring session user input data can include, by way of example, one or more physical characteristics of the user-designed virtual sponsor, one or more vocal characteristics of the user-designed virtual sponsor, and one or more personality characteristics of the user-designed virtual sponsor, so that the one of the plurality of users can generate a modified user-designed virtual sponsor 465, 470, 475 to be associated with the personal user profile of the one of the plurality of users.

The computer implemented method can additionally include, for example, the steps of presenting to the remote user interface device via the communications network, responsive to the operation of controlling the user-driven virtual sponsoring session, one or more virtual sponsoring statements selected from one or more of the plurality of lists of virtual sponsoring statements stored in a fourth database and associated with at least one of the one or more user-driven virtual sponsoring session controls 490, 495, receiving user response data from the remote user interface device via the communications network responsive to each of the one or more presented virtual sponsoring statements 500, and storing the user response data 505. Additionally, such a computer implemented method can include, for example, the step of presenting to the remote user interface device via the communications network, responsive to the operation of controlling the user-driven virtual sponsoring session and user response data received from the remote user interface device via the communications network responsive to each of the one or more presented virtual sponsoring statements 500, one or more virtual sponsoring statements selected from one or more of the plurality of lists of virtual sponsoring statements stored in the fourth database and associated with at least one of the one or more user-driven virtual sponsoring session controls 520.

In addition to the aforementioned steps, a computer implemented method according to an exemplary embodiment of the present invention can further include, by way of example, the step of creating, via the computer, responsive to the user response data and based on one or more of the plurality of virtual sponsoring statement components stored in a fifth database, one or more new virtual sponsoring statements to be categorized by topic 510, stored in the one or more of the plurality of lists of virtual sponsoring statements stored in the fourth database 515, and transmitted to the remote user interface device, via the communications network 520. Moreover, a computer implemented method according to an embodiment of the present invention can include the steps of bookmarking, responsive to receiving a sponsoring session termination signal from the remote user interface device via the communications network 480, the user-driven virtual sponsoring session by creating a user-driven virtual sponsoring session snapshot 525, storing the user-driven virtual sponsoring snapshot in the third database, and recommending, responsive to the virtual sponsoring control module, one or more actions for the one of the plurality of users to complete after termination of the user-driven virtual sponsoring session 535. The user-driven virtual sponsoring snapshot can include, for example, the one or more virtual sponsoring statements most recently presented to the user and the user response data received responsive to the each of the most recently presented one or more virtual sponsoring statements.

According to an embodiment of the invention, the computer implemented method can further include a virtual sponsoring session transcript generator. The virtual sponsoring session transcript generator can, for example, record transcripts of the virtual sponsoring statements and corresponding user responses in each virtual sponsoring session and transmit the transcripts to the user interface device via the communication network in order for the one of the plurality of users to review his or her virtual sponsoring session.

According to an exemplary embodiment of the present invention, the computer implemented method can further include the steps of orienting the one of the plurality of users to the user-driven virtual sponsoring system by providing a virtual sponsoring introduction 435, collecting, via the remote user interface device through the communications network, personal user data of the one of the plurality of users 415, and assigning a user name and a password to the one of the plurality of users. The virtual sponsoring introduction 435 can include, for example, an overview of the virtual sponsoring process, a description of one or more sponsoring session types, and a description of one or more sponsoring statement forms. In an exemplary embodiment of the present invention, the personal user data collected via the remote user interface device can include one or more of: family background, educational background, profession background, level of knowledge regarding virtual sponsoring, and one or more personal goals. Using the user name and password assigned to the one of the plurality of users, the one of the plurality of users can transmit to the computer from the remote user interface device via the communications network the assigned user name and password to thereby gain access to one or more virtual sponsoring sessions. Specifically, the computer implemented method can include the steps of prompting the one of the plurality of users to provide an assigned user name and password 405, and receiving the assigned user name and password of the one of the plurality of users from the remote user interface device via the communications network 410.

According to another exemplary embodiment of the present invention, the remote user interface device can include a graphical user interface device, and the second database can include one or more virtual sponsor data files defining one or more pre-designed default virtual sponsors. Accordingly, the step of generating, via the computer, a user-designed virtual sponsor can further include, for example, the steps of displaying, via the graphical user interface device of the remote user interface device, one or more of the one or more pre-designed default virtual sponsors 460, and generating a user-designed virtual sponsor 465 to be stored in the second database and associated with the personal user profile of the one of the plurality of users responsive to user input data received from the remote user interface device selecting one of the one or more pre-designed default virtual sponsors and user input data modifying one or more of: physical characteristics of the selected one of the one or more pre-designed default virtual sponsors, vocal characteristics of the selected one of the one or more pre-designed default virtual sponsors, and personality characteristics of the selected one of the one or more pre-designed default virtual sponsors so that a collective combination of the selected one of the one or more pre-designed default virtual sponsors and the modified physical, vocal, and personality characteristics of the one of the one or more pre-designed virtual sponsors generate a user-designed virtual sponsor. Moreover, according to an embodiment of the present invention, the computer implemented method can include the step of generating a user-designed virtual sponsor solely based on the personal user profile of the one of the plurality of users and without any user input data 455.

A computer implemented method, according to an embodiment of the present invention, can also include, for example, the step of updating the personal user profile of the one of the plurality of users responsive to receiving during the user-driven virtual sponsoring session, user profile update input data from the one of the plurality of users via the remote user interface device through the communications network. Additionally, the user profile update input data can include one or more of: personal user data, one or more preferred sponsoring session types, and one or more preferred sponsoring statement forms.

Beneficially, the one or more lists of virtual sponsoring statements can be a finite list of sequentially ordered statements each identifiable by a statement identifier. Additionally, the user-driven virtual sponsoring session snapshot can include a virtual sponsoring session progress indicator indicating progress made by the one of the plurality of users through each of the one or more of the plurality of lists of virtual sponsoring statements associated with one or more of the one or more virtual sponsoring statements presented to the remote user interface device via the communications network during the user-driven virtual sponsoring session to thereby indicate the progress of the one of the plurality of users through each of the selected one or more of the plurality of lists of virtual sponsoring statements. Accordingly, a computer implemented method according to an embodiment of the present invention can further include the step of associating the user-driven virtual sponsoring session snapshot with the personal user profile of the one of the plurality of users to thereby update the personal user profile of the one of the plurality of users 530.

As is perhaps best illustrated in FIG. 7, upon accessing the virtual sponsoring system 600, the one of the plurality of users can provide user input data indicating whether the user is a new user or a returning user 605. If the one of the plurality of users is a new user, the one of the plurality of users can provide personal user data to the system to create a personal user profile 615. Responsive to provided personal user data, the one of the plurality of users can be assigned a user name and a password which the user can provide to the virtual sponsoring system to thereby access one or more virtual sponsoring sessions 610. Once the one of the plurality of users has gained access to the virtual sponsoring system, the user can provide, for example, one or more virtual sponsoring session preferences 620 including one or more preferred sponsoring session types and one or more preferred sponsoring statement forms. Additionally, the user can select, according to an exemplary embodiment of the present invention, whether to use a virtual sponsor designed based on the personal profile of the one of the one of the plurality of users, or a user-designed virtual sponsor based on the collective combination of one or more physical characteristics of a virtual sponsor selected by the one of the plurality of users, one or more vocal characteristics of a virtual sponsor selected by the one of the plurality of users, and one or more personality characteristics of a virtual sponsor selected by the one of the plurality of users 625.

If the one of the plurality of users selects to design a user-designed virtual sponsor, embodiments of the present invention can, for instance, display for selection and modification by the one of the plurality of users, one or more pre-designed default virtual sponsors 630. The one of the plurality of users, for example, can accordingly select and modify one or more of the one or more pre-designed default virtual sponsors 635. Moreover, according to exemplary embodiments of the present invention, at any time during a virtual sponsoring session, the one of the plurality of users can select to modify the user-designed virtual sponsor associated with the one of the plurality of users 640. The user can, for example, also provide a topic of the user-driven virtual sponsoring session 645. Based on the selected user-driven virtual sponsoring session topic and using the user-designed virtual sponsor associated with the one of the plurality of users, one or more virtual sponsoring statements selected from one or more of a plurality of lists of virtual sponsoring statements can be, for instance, presented to the one of the plurality of users for evaluation 650. Subsequent to receiving the one or more virtual sponsoring statements, the one of the plurality of users, for example, can provide user response data responsive to each of the one or more virtual sponsoring statements 655. One or more additional virtual sponsoring statement selected from one or more of the plurality of lists of virtual sponsoring statements, for example, can also be presented to the one of the plurality of users responsive to the user response data received from the one of the plurality of users 665. Beneficially, at any time during the one or more virtual sponsoring sessions, the one of the plurality of users can select to exit the one or more virtual sponsoring sessions 660, and upon such selection, the one of the plurality of users can, for example, log off the virtual sponsoring system 670.

An exemplary embodiment of the present invention can also include a computer implemented method to facilitate an on-demand, user-driven, virtual sponsoring session for one or more user-selected topics through user-designed virtual sponsors. As illustrated in FIG. 6, the computer implemented method, beneficially can include, for example, the steps of generating, via a computer, a personal user profile 420 derived from a plurality of personal user data received from a remote user interface device via a communications network 415 and associated with the one of the plurality of users to be stored in the personal user profile stored in a first database 430, and generating, via the computer and responsive to the user profile of the one of the plurality of users, a user-designed virtual sponsor 465 to be stored in a second database and associated with the personal user profile of the one of the plurality of users. Advantageously, the operation of generating the user-designed virtual sponsor 465 can be responsive to the virtual sponsor characteristics data 450 generated by selection, by the one of the plurality of users, of one or more characteristics of a virtual sponsor so that a collective combination of the selected one or more characteristics of a virtual sponsor generate a user-designed virtual sponsor.

The computer implemented method can additionally include, for example, the step of controlling, via the computer, the user-driven virtual sponsoring session based on the personal user profile of the one of the plurality of users and responsive to receiving during the user-driven virtual sponsoring session one or more user-driven virtual sponsoring session controls 485 from the remote user interface device to be associated with the personal user profile of the one of the plurality of users to thereby allow the one of the plurality of users to modify the user-driven virtual sponsoring session by controlling one or more of: the topic of the user-driven virtual sponsoring session, the virtual sponsoring session type, or the virtual sponsoring statement form. The computer implemented method can also include, for instance, the steps of presenting to the remote user interface device via the communications network, responsive to the operation of controlling the user-driven virtual sponsoring session, one or more virtual sponsoring statements 500 selected from one or more of the plurality of lists of virtual sponsoring statements stored in a fourth database and associated with at least one of the one or more user-driven virtual sponsoring session controls 490, 495, and presenting to the remote user interface device via the communications network, responsive to the operation of controlling the user-driven virtual sponsoring session and user response data received from the remote user interface device via the communications network responsive to each of the one or more presented virtual sponsoring statements 500, one or more virtual sponsoring statements selected from one or more of the plurality of lists of virtual sponsoring statements stored in the fourth database and associated with at least one of the one or more user-driven virtual sponsoring session controls 520.

Also according to an exemplary embodiment of the present invention, the computer implemented method can further include, for example, the step of creating, via the computer, responsive to the user response data and based on one or more of the plurality of virtual sponsoring statement components stored in a fifth database, one or more new virtual sponsoring statements to be categorized by topic 510, stored in the one or more of the plurality of lists of virtual sponsoring statements stored in the fourth database 515, and transmitted to the remote user interface device, via the communications network 520. Beneficially, the one or more characteristics of a virtual sponsor include one or more physical characteristics of a virtual sponsor, one or more vocal characteristics of a virtual sponsor, and one or more personality characteristics of a virtual sponsor. Moreover, the one or more user-driven virtual sponsoring session controls can include, by way of example only, one or more virtual sponsoring topics 485, one or more virtual sponsoring session types, and one or more virtual sponsoring statement forms.

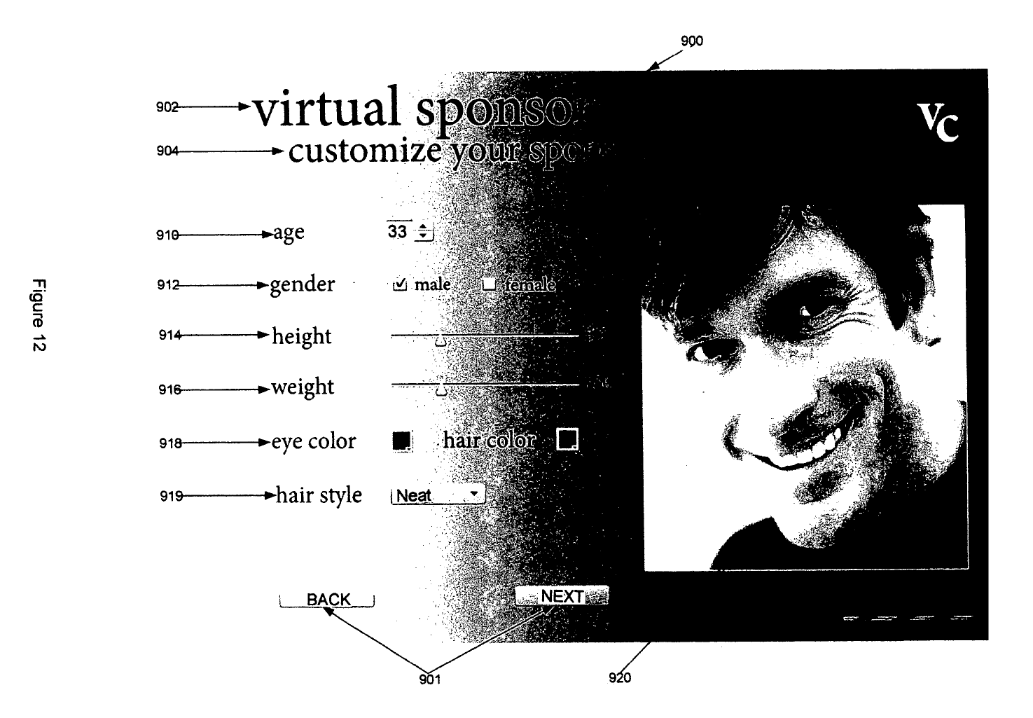

Exemplary embodiments of the present invention can also include a graphical user interface 900 to facilitate the design of one or more physical characteristics of a user-designed virtual sponsor, as is perhaps best illustrated by FIG. 12. By way of example only, the graphical user interface can be an Internet website, accessible via the communications network, and can include a graphical user interface title 902, a graphical user interface subtitle 904, and one or more graphical user interface input components to receive input from the one of the plurality of users selecting one or more physical characteristics of a user-designed virtual sponsor 910, 912, 914, 916, 918, 919. Specifically, according to this exemplary embodiment of the present invention, the one of the plurality of users can select the age of the user-designed virtual sponsor using a graphical user interface spinner 910. The one of the plurality of users can additionally, for instance, select the gender of the user-designed virtual sponsor by using a check box to select “male” or “female” 912. Moreover, the one of the plurality of users can select the height 914 and the weight 916 of the user-designed virtual sponsor by sliding a slider to the desired respective height 914 or weight 916. The one of the plurality of users, for example, can select the eye color and the hair color of the user-designed virtual sponsor using a color pallet 918, and the hair style of the one of the plurality of virtual sponsors using a drop-down list 919. Furthermore, the graphical user interface can include, for instance, navigation buttons such as “BACK” and “NEXT” 901.

Perhaps most beneficially, the graphical user interface device, according to an exemplary embodiment of the present invention, can include a graphical representation of the user-designed virtual sponsor 920. The graphical representation of the user-designed virtual sponsor 920 can be a drawing, a photograph, an animated drawing, an animated photograph, a video, a moving picture, a projection, a three-dimensional projection, a holograph, or any other form of graphical media as is known and understood by those skilled in the art. In one embodiment of the present invention, the user-designed virtual sponsor can be projected in front of or next to the user. Furthermore, the user can use the virtual sponsor program to project himself or herself with certain characteristics that the user lacks. For example, a user who stutters can project himself or herself with his/her own voice but without stuttering. Note, however, that the graphical representation of the user-designed virtual sponsor is by way of example only, and the user-designed virtual sponsor can be represented without graphical media by means of, for instance, audio or text. All communication during the virtual sponsoring session can be facilitated by a user-designed virtual sponsor. The one of the plurality of users, for example, can communicate with the virtual sponsor in a natural language dialog just as if the user-designed virtual sponsor is a human person. For instance, any virtual sponsoring statements presented to the one of the plurality of users can be presented by the user-designed virtual sponsor via graphical media as in this particular graphical user interface or by other means such as audio or text. The one of the plurality of users can respond to the one or more statements presented by the user-designed virtual sponsor in conversational form. Such responses from the one of the plurality of users need not be answers to the one or more virtual sponsoring statements but rather, such responses can be, for example, comments, requests for clarification, requests to change topic, requests to terminate the user-driven virtual sponsoring session, or any other statement. Each virtual sponsoring session, can be for instance, a natural language dialog conversation between the one of the plurality of users and a user-designed virtual sponsor.

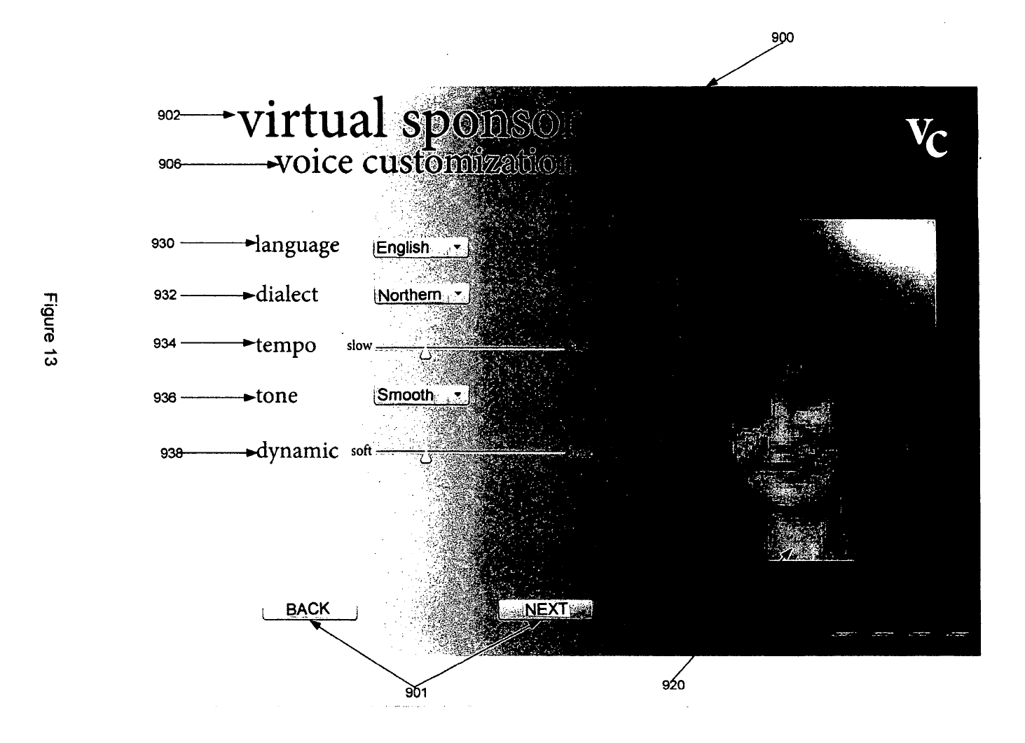

As perhaps best illustrated in FIG. 13, embodiments of the present invention can also include a graphical user interface 900 to facilitate the design of one or more vocal characteristics of a virtual sponsor by one of a plurality of users. Similarly to FIG. 12, the graphical user interface can include, by way of example only, a graphical user interface title 902, a graphical user interface subtitle 906, navigation buttons such as “BACK” and NEXT” 901, a graphical representation of the user-designed virtual sponsor 920, and one or more graphical user interface input components to receive input from the one of the plurality of users selecting one or more vocal characteristics of a user-designed virtual sponsor 930, 932, 934, 936, 938. Particularly, the one of the plurality of users can, for instance, select the language 930, dialect 932, and tone 936 of the user-designed virtual sponsor using a drop-down list, and the tempo 934 and dynamic 938 of the user-designed virtual sponsor by sliding a slider to the desired respective tempo 934 and dynamic 938.

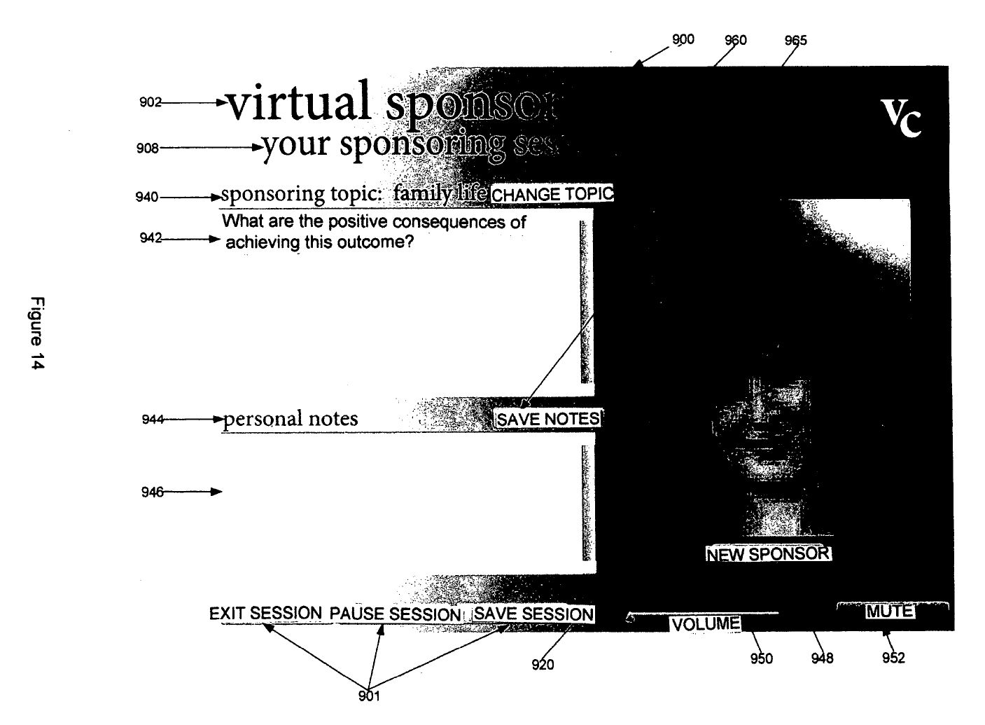

Furthermore, as is perhaps best illustrated in FIG. 14, embodiments of the present invention, for example, can include a graphical user interface 900 to facilitate an on-demand, user-driven virtual sponsoring session. Similarly to FIG. 12, and FIG. 13, the graphical user interface can include, for example, a graphical user interface title 902, and a graphical user interface subtitle 908. In this particular exemplary embodiment of the present invention, the user-driven virtual sponsoring session is set up as an interactive video chat session between a user-designed virtual sponsor 920 and one of the plurality of users. Accordingly, such a graphical user interface can include, for instance, user interface buttons 901 to exit the user-driven virtual sponsoring session, pause the user-driven virtual sponsoring session, and save the user-driven virtual sponsoring session. Additionally, the graphical user interface device can beneficially include a user interface button to change the virtual sponsoring session topic 960 and a user interface button to save notes of the one of the plurality of users recorded during the user-driven virtual sponsoring session 965. Furthermore, the graphical user interface device can include a text field identifying the current user-selected topic of the user-driven virtual sponsoring session 940. Importantly, the graphical user interface can also include components to facilitate communication between the one of the plurality of users and the user-designed virtual sponsor, including by way of example only, a text field to display, using alphanumeric characters, one or more virtual sponsoring statements presented to the one of the plurality of users from the user-designed virtual sponsor 942 and a text field to capture user input data including personal notes of the one of the plurality of users 944, 946.

In this particular exemplary embodiment of the present invention, as illustrated by FIG. 14, the user-designed virtual sponsor can also present one or more virtual sponsoring statements to the one of the plurality of users through graphical media representation of the user-designed virtual sponsor 920 and audio. Accordingly, the graphical user interface further includes, for instance, a slider to facilitate user selection of the volume of the user-designed virtual sponsor 950 and a user interface button to “MUTE” the audio of the user-designed virtual sponsor 952. Advantageously, the graphical user interface can also include, for example, a user interface button to facilitate selection and modification, by the one of the plurality of users, of a user-designed virtual sponsor. For instance, at any time during the user-driven virtual sponsoring session, the one of the plurality of users can click a user interface button, “NEW SPONSOR” 948, to transition to another graphical user interface to facilitate the selection and modification of a user-designed virtual sponsor.

It is important to note that while various embodiments of the present invention have been described in the context of a fully functional system, those skilled in the art will appreciate that the mechanism of at least portions of the present invention or aspects thereof are capable of being distributed in the form of a computer readable program product stored in a tangible computer medium and a computer readable medium of instructions in a variety of forms for execution on a processor, processors, or the like, and that the present invention applies equally regardless of the particular type of signal bearing media used to actually carry out the distribution.

Various embodiments of the present invention provide at least nine primary benefits: (1) exemplary embodiments of the present invention can provide high-quality sponsoring services at a low cost to each of the plurality of users; (2) embodiments of the present invention can provide virtual sponsoring sessions on-demand, at any time and at any place; (3) embodiments of the present invention can allow each of the plurality of users to select and design the physical, vocal, and personality characteristics of a user-designed virtual sponsor; (4) embodiments of the present invention can allow each of the plurality of users to bookmark virtual sponsoring session progress, pause an associated virtual sponsoring session, and return to the associated virtual sponsoring session at a later date as if the session was never paused; (5) embodiments of the present invention can facilitate user-driven virtual sponsoring sessions in a completely confidential manner; (6) embodiments of the present invention can facilitate user-driven virtual sponsoring sessions for any subject matter; (7) embodiments of the present invention can facilitate user-driven virtual sponsoring sessions that adapt, in real time, to new subject matter issues raised by each of the plurality of users; (8) embodiments of the present invention can facilitate user-driven virtual sponsoring sessions that can create new virtual sponsoring statements responsive to user input data thereby providing each of the plurality of users with a limitless set of virtual sponsoring statements to be used in one or more user-driven virtual sponsoring sessions; and (9) embodiments of the present invention can facilitate user-driven, co-coaching sponsoring sessions that allow multiple users to access the virtual sponsoring statements to be used to coach other users.

In the drawings and specification, there have been disclosed a typical preferred embodiment of the invention, and although specific terms are employed, the terms are used in a descriptive sense only and not for purposes of limitation. The invention has been described in considerable detail with specific reference to these various illustrated embodiments. It will be apparent, however, that various modifications and changes can be made within the spirit and scope of the invention as described in the foregoing specification and as defined in the appended claims.

1. (canceled)

2. A system as defined in claim 60,
wherein the database of the virtual sponsor computer includes a first, second, third, fourth, and fifth database, the first database including a plurality of user profiles each associated with one of a plurality of users, the second database including a plurality of virtual sponsor data files, the third database including a plurality of virtual sponsoring session data, the fourth database including a plurality of lists of virtual sponsor statements, each associated with at least one or more user-driven virtual sponsoring session controls, and the fifth database including a plurality of virtual sponsoring statement components;
wherein the first computer readable program product further includes instructions that, when executed by the virtual sponsor computer, cause the virtual sponsor computer to perform the operations of:
storing the personal user profile associated with the one of the plurality of users and received from the user interface device in the first database,
storing the user-designed virtual sponsor generated responsive to the personal user profile associated with the one of the plurality of users in the second database,
storing the user-driven virtual sponsoring session generated responsive to generating the user-designed virtual sponsor and responsive to receiving from the user interface device the set of virtual sponsoring preferences in the third database; and
wherein the third computer readable program product further includes instructions that, when executed by the virtual sponsor computer, cause the virtual sponsor computer to perform the operations of:
categorizing the one or more new virtual sponsoring statements, created responsive to the second computer program product and the user response data, by topic, and
storing the one or more new virtual sponsoring statements created responsive to the second computer readable program product and the user response data in the fourth database.

3. A system as defined in claim 57,
wherein the one or more characteristics of the user-designed virtual sponsor includes one or more of: text writing display characteristics, one or more physical characteristics of the user-designed virtual sponsor, one or more vocal characteristics of the user-designed virtual sponsor, and one or more personality characteristics of the user-designed virtual sponsor.

4. A system as defined in claim 60, wherein the user interface device is connected to the virtual sponsor computer.

5. A system as defined in claim 60, wherein the user interface device is positioned remote from the virtual sponsor computer and in communication with the virtual sponsor computer via a communications network.

6. A system as defined in claim 60, wherein the user response data includes one or more of language-based communication, voice quality, body language, facial expression, and vital signs.

7. (canceled)

8. A system as defined in claim 5,
wherein the third computer readable program product further includes instructions that, when executed by the virtual sponsor computer, cause the virtual sponsor computer to perform the operations of:
bookmarking, responsive to receiving a sponsoring session termination signal from the user interface device, the user-driven virtual sponsoring session by creating a user-driven virtual sponsoring session snapshot, the user-driven virtual sponsoring snapshot including the one or more virtual sponsoring statements most recently presented to the user and the user response data received responsive to the each of the most recently presented one or more virtual sponsoring statements, and
recommending, responsive to receiving the sponsoring session termination signal from the remote user interface device via the communications network, one or more actions for the one of the plurality of users to complete after termination of the user-driven virtual sponsoring session.

9-12. (canceled)

13. A system as defined in claim 2,
wherein the computer readable program product further includes instructions that, when executed by the virtual sponsor computer, cause the virtual sponsor computer to perform the operation of generating a transcript of the virtual sponsoring session statements and user response data of the one of the plurality of users received by the virtual sponsor computer during the user-driven virtual sponsoring session and presenting the transcript to the user interface device.

14-56. (canceled)

57. A system to facilitate an on-demand, user-driven, virtual sponsoring session for one or more user-selected topics through user-designed virtual sponsors, the system comprising:
a virtual sponsor computer positioned to facilitate a user-driven virtual sponsoring session for one of a plurality of users, the virtual sponsor computer having at least a processor, a memory and a database; and
a first computer readable program product stored in a tangible computer medium and including instructions that, when executed by the virtual sponsor computer, cause the virtual sponsor computer to perform the operations of:
generating a user-designed virtual sponsor also being responsive to virtual sponsor characteristics data generated by selection, by the one of the plurality of users, of one or more characteristics of a virtual sponsor, so that a collective combination of the selected one or more characteristics of a virtual sponsor generate a user-designed virtual sponsor.

58. The system of claim 57, further comprising program selected virtual sponsor characteristics responsive to a personal user profile derived from a plurality of personal user data associated with the one of the plurality of users and received from a user interface device.

59. The system of claim 58, wherein said user-designed virtual sponsor is associated with the personal user profile.

60. The system of claim 57, wherein the virtual sponsor computer further comprises the operation of generating a user-driven virtual sponsoring session responsive to generating the user-designed virtual sponsor and responsive to receiving from the user interface device the set of virtual sponsoring session preferences.

61. The system of claim 60, further comprising a second computer readable program product stored in a tangible computer medium and including instructions that, when executed by the virtual sponsor computer, causes the virtual sponsor computer to perform the operations of controlling the user-driven virtual sponsoring session based on the personal user profile of the one of the plurality of users and responsive to receiving during the user-driven virtual sponsoring session one or more user-driven virtual sponsoring session controls from the user interface device to be associated with the personal user profile of the one of the plurality of users.

62. The system of claim 61, wherein the design of the user-designed virtual sponsor is controlled based on the personal user profile of the one of the plurality of users and responsive to receiving during the user-driven virtual sponsoring session user input data modifying one or more characteristics of the user-designed virtual sponsor to thereby generate a modified user-designed virtual sponsor to be associated with the personal user profile of the one of the plurality of users.

63. The system of claim 60, further comprising:
a third computer readable program product stored in a tangible computer medium and including instructions that when executed by the virtual sponsor computer, cause the virtual sponsor computer to perform the operations of:
presenting to the user interface device, responsive to the second computer readable program product, one or more virtual sponsoring statements selected from one or more of a plurality of lists of virtual sponsoring statements associated with at least one of the one or more user-driven virtual sponsoring session controls and stored in the database.

64. The system of claim 63, wherein the virtual sponsor computer further comprises the operation of:
presenting to the user interface device, responsive to the second computer readable program product and user response data received from the user interface device responsive to each of the one or more presented virtual sponsoring statements, one or more virtual sponsoring statements selected from one or more of the plurality of lists of virtual sponsoring statements associated with at least one of the one or more user-driven virtual sponsoring session controls and stored in the database

65. The system of claim 64, wherein the virtual sponsor computer further comprises the operation of:
creating, responsive to the second computer readable program product and the user response data and based on one or more of a plurality of virtual sponsoring statement components stored in the database, one or more new virtual sponsoring statements different from the virtual sponsoring statements in each of the plurality of lists of virtual sponsoring statements stored in the database and to transmit to the user interface device the one or more new virtual sponsoring statements

66. A system to facilitate an on-demand, user-driven, personalized virtual sponsoring session for one or more user-selected topics, the system comprising:
a virtual sponsor computer positioned to facilitate a user-driven virtual sponsoring session for one of a plurality of users, the virtual sponsor computer having at least a processor, a memory and a database;
a first computer readable program product stored in a tangible computer medium and including instructions that, when executed by the virtual sponsor computer, cause the virtual sponsor computer to perform the operations of:
generating a user-driven virtual sponsoring session responsive to receiving from the user interface device the set of virtual sponsoring session preferences to be associated with the personal user profile of the one of the plurality of users, the user-driven virtual sponsoring session being based on the personal user profile of the one of the plurality of users, including a) creating one or more new virtual sponsoring statements or questions based on but different from the virtual sponsoring statements or questions stored in the database, and b) transmitting to the user interface device the one or more new virtual sponsoring statements or questions.

67. A co-sponsoring computer system comprising:
a data base of sponsoring questions or statements for at least one sponsoring topic;
a computer readable program enabling a user acting as sponsor to use said questions or statements in proving an interactive sponsoring session; and
a computer readable program enabling a user to receive said sponsoring session.

68. The co-sponsoring computer system of claim 67, further comprising a computer readable program that modifies existing or creates new questions or statements by using at least one of either a) personal user profile, b) responses or c) personal preferences of said sponsored user.

69. The co-sponsoring computer system of claim 67, further comprising a computer readable program or computer interface enabling sponsored user and user acting as sponsor to find each other and arrange for one or more sponsoring sessions using internet.
